(19) United States
(12) Patent Application Publication
(10) Pub. No.: US 2025/0371584 A1
(43) Pub. Date: Dec. 4, 2025

(54) DELIVERY SYSTEM, DELIVERY METHOD, GENERATIVE AI SYSTEM, GENERATIVE AI METHOD, CONTENT PROVIDING SYSTEM, AND SERVICE PROVIDING METHOD

(71) Applicant: Originator Profile Collaborative Innovation Partnership, Tokyo (JP)

(72) Inventor: Yoshifumi TAKEUCHI, Tokyo (JP)

(21) Appl. No.: 19/307,523

(22) Filed: Aug. 22, 2025

Related U.S. Application Data
(63) Continuation-in-part of application No. 17/905,780, filed on Sep. 7, 2022.

(30) Foreign Application Priority Data
Mar. 16, 2020 (JP) 2020-045725
May 30, 2025 (JP) 2025-090400

(51) Int. Cl. G06Q 30/0241; H04L 9/32

(52) U.S. Cl. CPC G06Q 30/0277; H04L 9/3247; H04L 9/3268

(57) ABSTRACT

A delivery system includes a memory; and a processor coupled to the memory. The processor is configured to: attach a first certificate and a second certificate to an advertisement, upon web content attached with the advertisement being delivered to a terminal, in which the first certificate is a certificate of a profile of an advertiser of the advertisement, the first certificate is previously issued using digital signature technology through examination performed by a predetermined certification institution, the second certificate is a certificate of a profile of the advertisement, and the second certificate is previously issued by the advertiser using the digital signature technology and certifies that the advertisement is not falsified; and determine reliability of the advertisement using the digital signature technology based on the first certificate and the second certificate that are attached to the advertisement.

### CROSS-REFERENCE TO RELATED APPLICATIONS

This application claims the benefit of and is a continuation-in-part of co-pending U.S. patent application Ser. No. 17/905,780 filed on Sep. 7, 2022, which is a U.S. national stage application from PCT/JP2020/023952 filed on Jun. 18, 2020, which is based on and claims priority to Japanese Patent Application No. 2020-045725 filed on Mar. 16, 2020. This application also claims priority to Japanese Patent Application No. 2025-090400 filed on May 30, 2025 under 35 U.S.C. § 119. The entire contents of the priority applications are incorporated by reference in their entireties.

### BACKGROUND

### 1. Field of the Invention

The present disclosure relates to a delivery system, a delivery method, a generative AI (artificial intelligence) system, a generative AI method, a content providing system, and a service providing method.

### 2. Description of the Related Art

Technology for providing an advertisement in web content, such as a web page or the like, by bidding or the like. See, for example, Japanese Laid-Open Patent Application Publication No. 2019-220052.

### SUMMARY

A delivery system according to an embodiment includes: a memory; and a processor coupled to the memory, the processor being configured to: attach a first certificate and a second certificate to an advertisement, upon web content attached with the advertisement being delivered to a terminal, in which the first certificate is a certificate of a profile of an advertiser of the advertisement, the first certificate is previously issued using digital signature technology through examination performed by a predetermined certification institution, the second certificate is a certificate of a profile of the advertisement, and the second certificate is previously issued by the advertiser using the digital signature technology and certifies that the advertisement is not falsified; and determine reliability of the advertisement using the digital signature technology based on the first certificate and the second certificate that are attached to the advertisement.

Also, a delivery system according to another embodiment includes: a memory; and a processor coupled to the memory, the processor being configured to: attach a first certificate and a second certificate to an article, upon the article being delivered to a terminal, in which the first certificate is a certificate of a profile of an organization of a provider of the article, the first certificate is previously issued using digital signature technology through examination performed by a predetermined certification institution, the second certificate is a certificate of a profile of the article, and the second certificate is previously issued by the organization of the provider of the article using the digital signature technology and certifies that the article is not falsified; and determine reliability of the article using the digital signature technology based on the first certificate and the second certificate that are attached to the article.

Also, a delivery method according to another embodiment includes: attaching a first certificate and a second certificate to an advertisement, upon web content attached with the advertisement being delivered to a terminal, in which the first certificate is a certificate of a profile of an advertiser of the advertisement, the first certificate is previously issued using digital signature technology through examination performed by a predetermined certification institution, the second certificate is a certificate of a profile of the advertisement, and the second certificate is previously issued by the advertiser using the digital signature technology and certifies that the advertisement is not falsified; and determining reliability of the advertisement using the digital signature technology based on the first certificate and the second certificate that are attached to the advertisement.

Also, a delivery method according to another embodiment includes: attaching a first certificate and a second certificate to an article, upon the article being delivered to a terminal, in which the first certificate is a certificate of a profile of an organization of a provider of the article, the first certificate is previously issued using digital signature technology through examination performed by a predetermined certification institution, the second certificate is a certificate of a profile of the article, and the second certificate is previously issued by the organization of the provider of the article using the digital signature technology and certifies that the article is not falsified; and determining reliability of the article using the digital signature technology based on the first certificate and the second certificate that are attached to the article.

Also, a generative AI system according to another embodiment includes a generative AI generator configured to generate a generative AI model using training data that is article information collected from a communication network, the generative AI system including: a memory; and a processor coupled to the memory, wherein the processor is configured to determine reliability of a generative AI company operating the generative AI generator using digital signature technology based on a certificate of a profile of the generative AI company, and the certificate is previously issued using the digital signature technology through examination performed by a predetermined certification institution.

Also, a generative AI method, according to another embodiment, preformed by a generative AI system including a generative AI generator configured to generate a generative AI model using training data that is article information collected from a communication network, the generative AI method including: determining reliability of a generative AI company operating the generative AI generator using digital signature technology based on a certificate of a profile of the generative AI company, wherein the certificate is previously issued using the digital signature technology through examination performed by a predetermined certification institution.

Also, a content providing system, according to another embodiment, configured to provide a service from a service providing server to a terminal to which web content is delivered, the content providing system including: a memory; and a processor coupled to the memory, the processor being configured to: record a first certificate and a second certificate as browsing log information, in which the first certificate is a certificate of a profile of an organization of a provider of the web content, the second certificate is a certificate of a profile of the web content that certifies that the web content is not falsified, and the first certificate and the second certificate are attached to the web content delivered to the terminal and are issued using digital signature technology; and provide user information, acquired through an analysis process of the browsing log information, to the service providing server, thereby providing the terminal with the service in accordance with the user information.

Also, a service providing method, according to another embodiment, of providing a service from a service providing server to a terminal to which web content is delivered, the service providing method including: recording a first certificate and a second certificate as browsing log information, in which the first certificate is a certificate of a profile of an organization of a provider of the web content, the second certificate is a certificate of a profile of the web content that certifies that the web content is not falsified, and the first certificate and the second certificate are attached to the web content delivered to the terminal and are issued using digital signature technology, and providing user information, acquired through an analysis process of the browsing log information, to the service providing server, thereby providing the terminal with the service in accordance with the user information.

### BRIEF DESCRIPTION OF THE DRAWINGS

FIG. 1 is a diagram illustrating an example of a system configuration of an advertisement delivery system according to a first embodiment of the present disclosure.

FIG. 2 is a diagram illustrating an example of a hardware configuration of each device included in the advertisement delivery system according to the first embodiment.

FIG. 3 is a diagram illustrating an example of a functional configuration of each device included in the advertisement delivery system according to the first embodiment.

FIG. 4A is a diagram illustrating examples of various types of information handled by the advertisement delivery system according to the first embodiment.

FIG. 4B is a diagram illustrating relationships between various signature keys handled by the advertisement delivery system according to the first embodiment.

FIG. 4C is a diagram illustrating a display example of icons included in a profile annotation (PA) displayed by the advertisement delivery system according to the first embodiment.

FIG. 5 is a sequence diagram illustrating an example of a procedure of an advertisement delivery process performed by the advertisement delivery system according to the first embodiment.

FIG. 6 is a diagram illustrating examples of various types of information handled by an article delivery system according to a second embodiment of the present disclosure.

FIG. 7 is a diagram illustrating an example of a service providing procedure performed by a content providing system according to a third embodiment of the present disclosure.

FIG. 8 is a diagram illustrating examples of various types of information handled by a generative AI system according to a fourth embodiment of the present disclosure.

### DETAILED DESCRIPTION OF THE DISCLOSURE

Related art has issues to address, such as delivery, from inappropriate distributors, of inappropriate information (e.g., fake news, content that infringes another person's copyright, content including personal information, and the like) and inappropriate advertisements.

Also, many people have emerged, such as those who impersonate entities, such as news organizations and government offices to transmit information in order to mislead others, or who irresponsibly disseminate falsehoods and misinformation at times of elections and disasters, endangering democracy and our lives. The influence of such people is increasing day by day.

In addition, in the “attention economy,” an economic model that relies on people's interest and attention as a source of income, excessive emphasis is placed on indicators, such as the number of views and the number of displays. Information created without any responsibility for its truthfulness is often circulated and spread, causing a social issue.

Furthermore, with the development and spread of generative AI, there is a trend in which information that is difficult to distinguish from the truth is easily generated and spread in large quantities.

In these ways, ordinary people are now being put in a situation where they passively consume information subject to unknown external controls, without being able to rationally recognize and judge its authenticity or reliability. This distortion in their perception of the authenticity of information will not only hinder the independent exercise of their right to know, but will also endanger the lives, bodies and property of individuals, and even democracy itself.

A delivery system according to one embodiment of the present disclosure increases reliability of content (e.g., web content and articles) and information attached to the content (e.g., advertisements).

Hereinafter, one embodiment of the present disclosure will be described with reference to the drawings.

Systems described in the present embodiment are implemented based on the definition of “reliability of information” described below.

In the systems, the “reliability of information” defines that: “information is provided accurately and consistently”; “information transmission entities are in compliance with information transmission policies they created”; and “information transmission entities have governance systems sufficient to realize their information transmission policies”.

Information transmission entities (including advertisers) who fulfill the above requirement “information is provided accurately and consistently” can provide information accurately and consistently. Thus, it is obvious that the “reliability of information” that is transmitted is higher than that of information transmission entities who do not fulfill this requirement.

Therefore, the systems described in the present embodiment use fulfillment of the requirement “information is provided accurately and consistently” as a basic condition for an issuance examination of a certificate issued in the systems.

The systems described in the present embodiment attach certificates to various types of information, and verify the certificates attached to the various types of information using digital signature technology, thereby certifying that content transmitted by information transmission entities is highly reliable information, i.e., content transmitted by information transmission entities who fulfill the above-described requirements for the “reliability of information” (i.e., information transmission entities who are certified by a third-party institution as fulfilling the above-described requirements for the “reliability of information”).

### First Embodiment

### (System Configuration of Advertisement Delivery System 1)

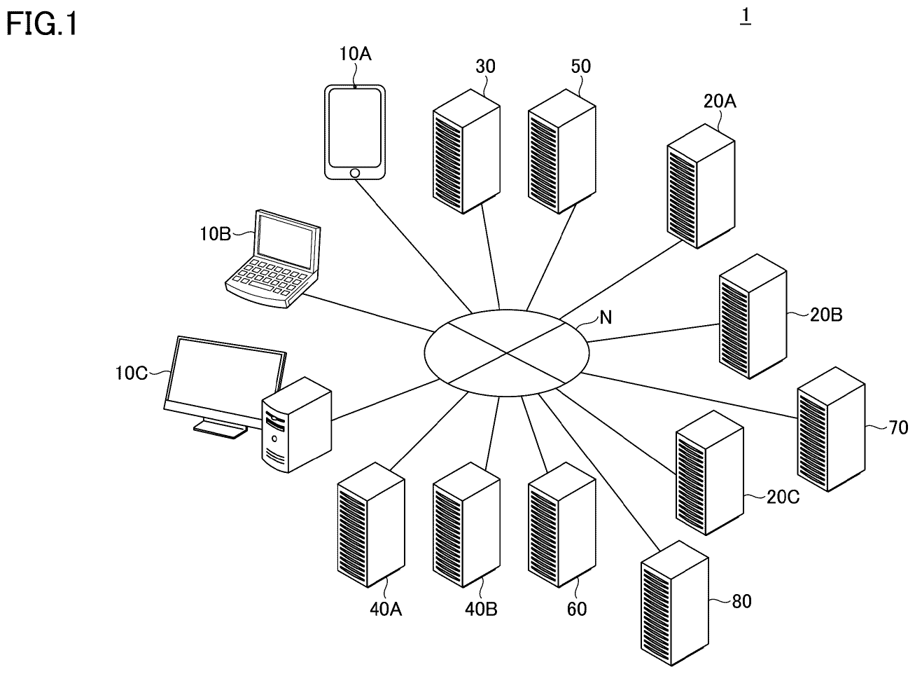

FIG. 1 is a diagram illustrating an example of a system configuration of an advertisement delivery system 1 according to a first embodiment of the present disclosure. In FIG. 1, the advertisement delivery system 1 includes a plurality of terminals 10 (terminals 10A, 10B, and 10C) and a plurality of content servers 20 (content servers 20A, 20B, and 20C). Also, the advertisement delivery system 1 includes an ad server 30, a plurality of advertiser servers 40 (advertiser servers 40A and 40B), a log server 50, a management server 60, a supply-side platform (SSP) 70, and a demand-side platform (DSP) 80.

The numbers of the terminals 10, the content servers 20, the ad server 30, the management server 60, the SSP 70, and the DSP 80 are not limited to the numbers in the example illustrated in FIG. 1.

The terminals 10, the content servers 20, the ad server 30, the advertiser servers 40, the log server 50, the management server 60, the SSP 70, and the DSP 80 are communicably coupled to each other by a communication network N, such as the Internet, a wireless local area network (LAN), a cell phone network, and the like.

The terminals 10 are information processing devices, for example, smartphones, tablet terminals, personal computers (PCs), and the like. Each terminal 10 displays, via a web browser or an application, content acquired from the content server 20 in response to an operation performed by a user.

The content servers 20, the ad server 30, the advertiser servers 40, and the log server 50 are, for example, information processing devices, such as server computers, personal computers, and the like.

Each content server 20 may be, for example, a web server that displays content of web pages, such as articles, blogs, and the like, and content of a social networking service (SNS) on the terminals 10.

In this case, for example, the content server 20 may transmit a specified piece of content to the terminal 10 in response to an acquisition request that specifies the identification information about the content and is transmitted from a web browser, an SNS application, or the like of the terminal 10. In this case, the identification information about the specified piece of content may be, for example, a uniform resource locator (URL). The acquisition request may be, for example, a hypertext transfer protocol (HTTP) request. The content server 20 may include the information about the specified piece of content in an HTML document, which is the information about the web page corresponding to the designated URL, and return the HTML document to the terminal 10.

The ad server 30 is a server that employs, for example, a method of real-time bidding (RTB) or the like to deliver advertisements of the entities operating the advertiser servers 40 to terminals 10 that access the content servers 20. The ad server 30 may be implemented by a plurality of servers. The ad server 30 may also include servers of various entities that act as ad exchanges for delivering advertisements to respective ad spaces of ad networks which include a plurality of SSPs and the like. Furthermore, the ad server 30 may include an ad server which delivers advertisements to websites.

Each advertiser server 40 is a server for delivering advertisements to the terminals 10 via the ad server 30. The advertiser servers 40 may include, for example, servers operated by advertiser entities or advertising agencies of the advertiser entities.

The log server 50 is a server for recording logs about reproduction of content, information about each advertisement delivered for the content, and the like. The log server 50 may be, for example, a database server operated by a predetermined institution. The log server 50 may be, for example, a distributed ledger server that records information by blockchain (distributed ledger). In this case, it may be arranged such that each of the various processing operations by the distributed ledger server is executed by a corresponding program (decentralized application (DApp)) which is stored as a smart contract and operates on the distributed ledger server.

The management server 60 is a device that functions as “originator profile (OP) issuing system” that manages various types of information about the reliability of organizations, advertisements, websites, and the like (core profile (CP), content attestation (CA), site profile (SP), profile annotation (PA), and the like described below). The management server 60 is operated by a predetermined public certification institution that certifies organizations, advertisements, websites, and the like.

The SSP 70 is a server that performs advertising transactions on a content provider side. For example, the SSP 70 is a platform for maximizing the revenue of content providers that display advertisements. For example, the SSP 70 performs RTB transactions with the DSP 80 on an advertiser side on behalf of the content providers.

The DSP 80 is a server that performs advertising transactions on the advertiser side. The DSP 80 is, for example, a platform for optimizing the advertising effect of the advertiser. For example, the DSP 80 performs RTB transactions with the SSP 70 on the content provider side on behalf of the advertisers.

### (Hardware Configuration of Each Device)

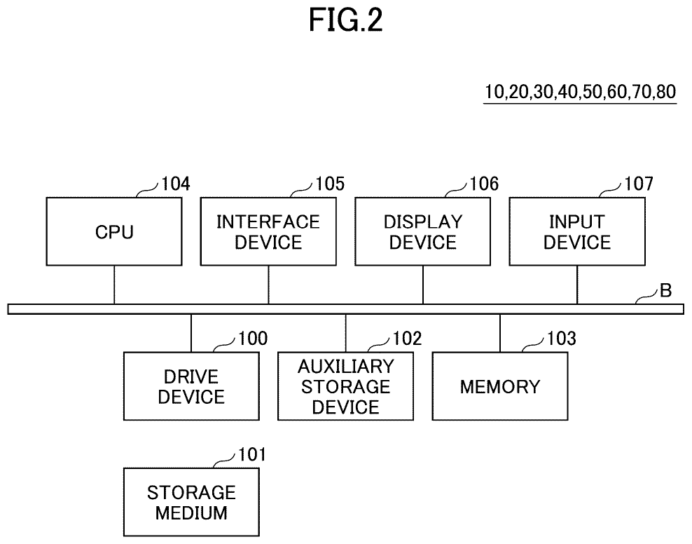

FIG. 2 is a diagram illustrating an example of a hardware configuration of each device included in the advertisement delivery system 1 according to the first embodiment. The following description is given assuming that each device included in the advertisement delivery system 1 has a common configuration.

As illustrated in FIG. 2, each device included in the advertisement delivery system 1 includes, a drive device 100, an auxiliary storage device 102, a memory 103, a central processing unit or processor (CPU) 104, an interface device 105, a display device 106, an input device 107, and the like, which are coupled to each other via a bus B.

A storage medium 101 provides programs for implementing processing in each device included in the advertisement delivery system 1. When the storage medium 101 that stores the programs is set in the drive device 100, the programs are installed from the storage medium 101 to the auxiliary storage device 102 via the drive device 100. Note that the installation of the programs need not always be performed by the storage medium 101. The programs may also be downloaded by another computer via a network. In addition to storing the installed programs, the auxiliary storage device 102 also stores necessary files, data, and the like.

When activation of a program is instructed, the memory 103 reads the program from the auxiliary storage device 102 and stores the program. The CPU 104 implements functions related to each device included in the advertisement delivery system 1 in accordance with the program stored in the memory 103. The interface device 105 is used as an interface for connecting to a network. The display device 106 is a display for displaying a graphical user interface (GUI) or the like of each program. The input device 107 receives inputs of various operation instructions. The input device 107 may include, for example, a microphone for collecting sound, a keyboard for receiving inputs of letters or the like when keys are pressed by a user, and the like.

Note that an example of the storage medium 101 may be a portable storage medium, such as a CD-ROM, a DVD disc, a USB memory, or the like. An example of the auxiliary storage device 102 may be, for example, a hard disk drive (HDD), a flash memory, or the like. The storage medium 101 and the auxiliary storage device 102 each correspond to a computer-readable storage medium.

### (Functional Configuration of Each Device)

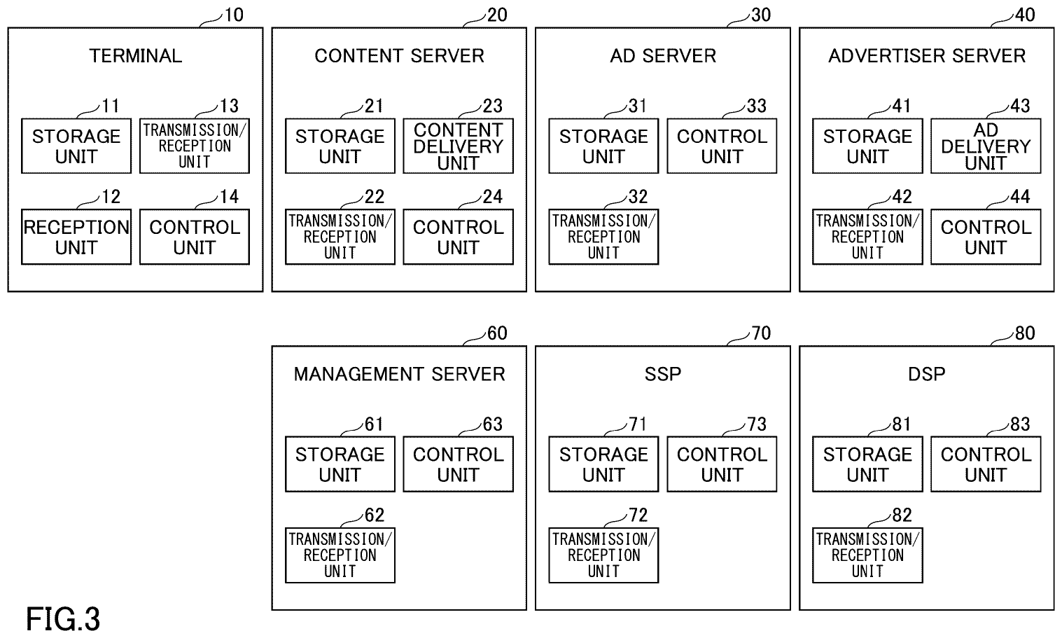

FIG. 3 is a diagram illustrating an example of a functional configuration of each device included in the advertisement delivery system 1 according to the first embodiment.

Each terminal 10 includes a storage unit 11, a reception unit 12, a transmission/reception unit 13, and a control unit 14. Each of these units may be implemented by the cooperation of one or more programs installed in the terminal 10 and hardware, such as, for example, the CPU 104 of the terminal 10.

The storage unit 11 may store, for example, user profiles and the like. The reception unit 12 receives various types of operation from a user of the terminal 10. The transmission/reception unit 13 transmits and receives data to and from external devices, such as the content servers 20, the advertiser servers 40, and the like. The control unit 14 controls each unit of the terminal 10.

Each content server 20 includes a storage unit 21, a transmission/reception unit 22, a content delivery unit 23, and a control unit 24. Each of these units may be implemented by the cooperation of one or more programs installed in the content server 20 and hardware, such as, for example, the CPU of the content server 20.

The storage unit 21 stores various types of information. The storage unit 21 may store, for example, profiles (e.g., publisher profiles) of content providers (e.g., publishers or bloggers). The transmission/reception unit 22 transmits and receives data to and from external devices, such as the terminals 10, the ad server 30, and the like. The content delivery unit 23 delivers content to the terminals 10. The control unit 24 controls each unit of the content server 20.

The ad server 30 includes a storage unit 31, a transmission/reception unit 32, and a control unit 33. Each of these units may be implemented by the cooperation of one or more programs installed in the ad server 30 and hardware, such as, for example, the CPU of the ad server 30.

The storage unit 31 stores various types of information. The storage unit 31 may store, for example, respective profiles (profiles of platform providers) of entities (platform providers) providing the platforms for delivering advertisements. The transmission/reception unit 32 transmits and receives data to and from external devices, such as the content servers 20, the advertiser servers 40, and the like. The control unit 33 controls each unit of the ad server 30.

Each advertiser server 40 includes a storage unit 41, a transmission/reception unit 42, an ad delivery unit 43, and a control unit 44. Each of these units may be implemented by the cooperation of one or more programs installed in the advertiser server 40 and hardware, such as, for example, the CPU of the advertiser server 40.

The storage unit 41 stores various types of information. The storage unit 41 may store, for example, core profiles (CPs) of advertising providers (advertisers) that provide advertisements to content. The storage unit 41 may also store, for example, core profiles (CPs) of advertising companies (ad agencies) that are the agencies of the advertisements. The transmission/reception unit 42 transmits and receives data to and from external devices, such as the ad server 30, the terminals 10, and the like. The ad delivery unit 43 delivers advertising content to the terminals 10. The control unit 44 controls each unit of the advertiser server 40.

The management server 60 includes a storage unit 61, a transmission/reception unit 62, and a control unit 63. Each of these units may be implemented by the cooperation of one or more programs installed in the management server 60 and hardware, such as, for example, the CPU of the management server 60.

The storage unit 61 stores various types of information. The transmission/reception unit 62 transmits and receives data to and from external devices, such as the content server 20, the ad server 30, the advertiser server 40, and the like. The control unit 63 controls each unit of the management server 60.

The SSP 70 includes a storage unit 71, a transmission/reception unit 72, and a control unit 73. Each of these units may be implemented by the cooperation of one or more programs installed in the SSP 70 and hardware, such as, for example, the CPU of the SSP 70. The storage unit 71 stores various types of information. The transmission/reception unit 72 transmits and receives data to and from external devices, such as the DSP 80 and the like. The control unit 73 controls each unit of the SSP 70.

The DSP 80 includes a storage unit 81, a transmission/reception unit 82, and a control unit 83. Each of these units may be implemented by the cooperation of one or more programs installed in the DSP 80 and hardware, such as, for example, the CPU of the DSP 80. The storage unit 81 stores various types of information. The transmission/reception unit 82 transmits and receives data to and from external devices, such as the SSP 70 and the like. The control unit 83 controls each unit of the DSP 80.

### (Examples of Various Types of Information)

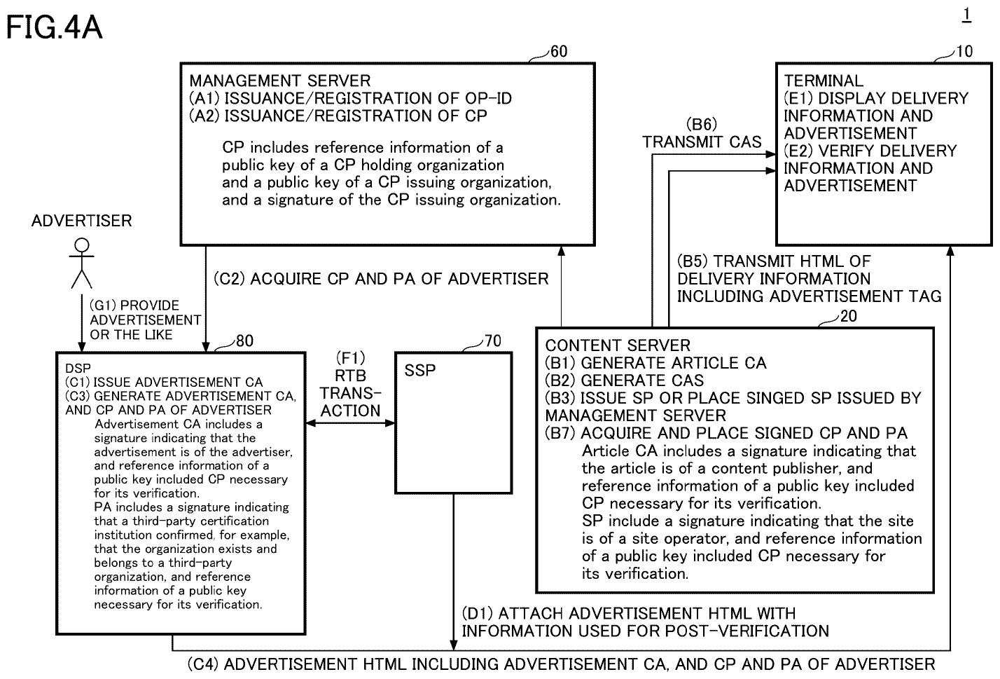

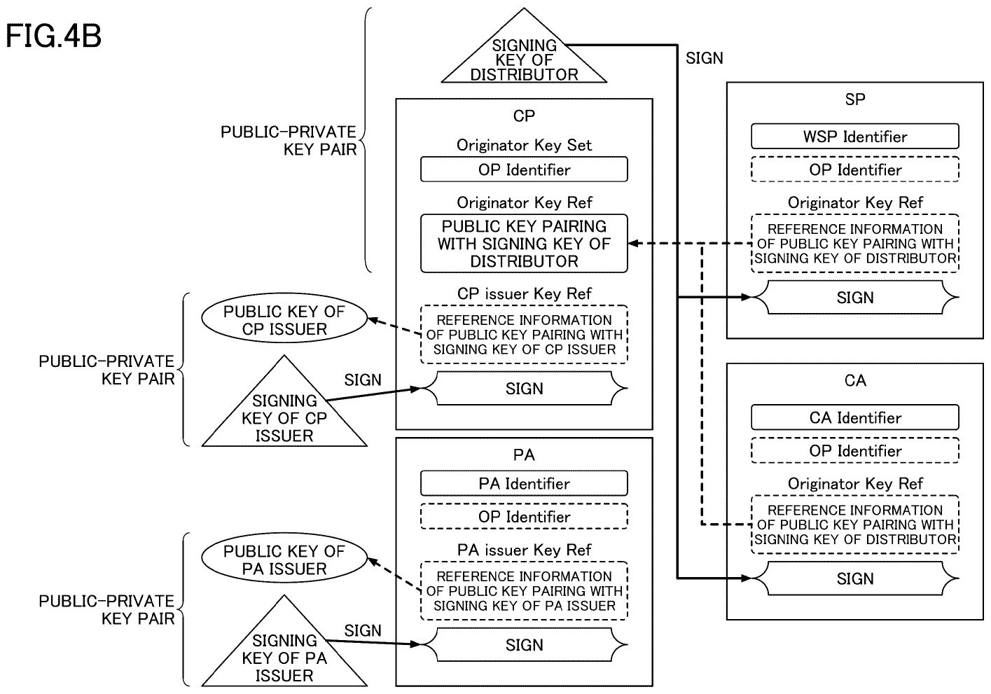

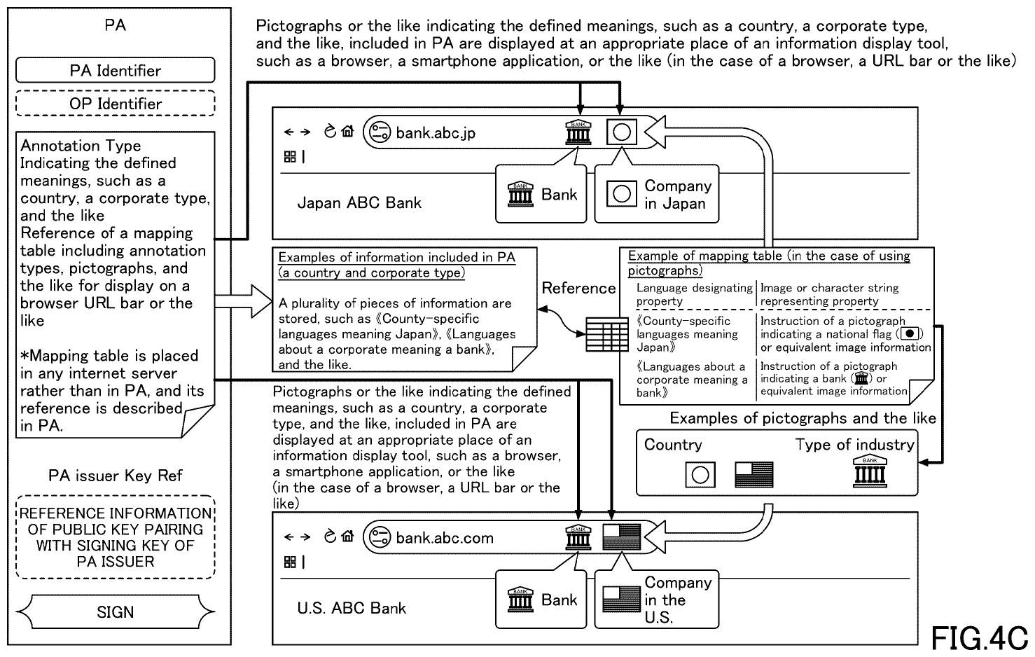

FIG. 4A is a diagram illustrating examples of various types of information handled by the advertisement delivery system 1 according to the first embodiment. FIG. 4B is a diagram illustrating relationships between various signature keys handled by the advertisement delivery system 1 according to the first embodiment.

As illustrated in (A1) of FIG. 4A, for each organization (e.g., advertisers, media companies, advertising intermediaries (DSP and SSP), or the like), the management server 60 issues an originator profile identifier (OP-ID), which is an identifier (ID) of the organization, and registers the OP-ID in an OP issuing system.

As illustrated in (A2) of FIG. 4A, for each organization (e.g., advertisers, media companies, advertising intermediaries (DSP and SSP), or the like), the management server 60 issues a CP (core profile), which is a certificate of an organization profile of the organization, and registers the CP in the OP issuing system.

As illustrated in (B1) of FIG. 4A, for each piece of article information, the content server 20 generates an article CA (issued by the content server 20), which is a certificate that can verify that the article information remains unchanged from that transmitted by an article transmission entity, i.e., the article information is not falsified.

As illustrated in (B2) of FIG. 4A, for each piece of article information, the content server 20 generates a CA set (CAS) including a CA list in the page.

As illustrated in (B7) of FIG. 4A, the content server 20 may place the digitally signed CP and PA, acquired from the management server 60, in the same server for enabling verification.

Note that the content server 20 need not always be configured to generate a CAS, and may be configured to provide only the article CA to a device to which the article information is delivered. In this case, the device to which the article information is delivered may be configured to verify reliability of a media company by acquiring the CP and PA of the media company from the management server 60, if necessary.

As illustrated in (B3) of FIG. 4A, for each web content site, the content server 20 issues a site profile (SP), which is a certificate enabling verification of information of the web content site. Note that the SP is issued for each site and thus need not be created for each item of content. In addition, rather than issuing the SP in the content server 20, the issuance of the SP may be performed by placing a signed SP issued by the management server 60.

The content server 20 may be configured not to generate CP, PA, and CA, and may be configured to provide only the CA to a device to which the website is delivered. In this case, the device to which the website is delivered may be configured to verify reliability of a media company by acquiring the CP and PA of the media company from the management server 60, if necessary.

As illustrated in (B5) of FIG. 4A, the content server 20 transmits, to the terminal 10, HTML of delivery information (websites, articles, or the like) including an advertisement tag.

As illustrated in (B6) of FIG. 4A, upon the article information being delivered to the terminal 10, the content server 20 transmits the CAS of the article information to the terminal 10.

Some of the functions of the content server 20 illustrated in FIG. 4A (e.g., generation and management of CAS) may be implemented by an external server provided outside the content server 20.

As illustrated in (C1) of FIG. 4A, for each advertisement, the DSP 80, which is a proxy server on the advertiser side, issues an advertisement CA, which is a certificate enabling verification that the advertisement is not falsified, using digital signature technology. As illustrated in (C2) of FIG. 4A, for each advertisement, the DSP 80 acquires the CP and PA of the advertiser of the advertisement from the management server 60. As illustrated in (C3) of FIG. 4A, for each advertisement, the DSP 80 generates the advertisement CA of the advertisement and the CP and PA of the advertiser of the advertisement. As illustrated in (C4) of FIG. 4A, upon delivery information (e.g., websites or articles) being transmitted to the terminal 10, the DSP 80 transmits, to the terminal 10, the advertisement HTML including the advertisement CA and the CP and PA of the advertiser.

As illustrated in (D1) of FIG. 4A, the SSP 70, which is a proxy server on the content provider side, attaches the advertisement HTML, transmitted from the DSP 80 to the terminal 10, with information used for post-verification performed by the terminal 10 (e.g., the OP-ID of the advertiser, information of the advertiser (domain or the like), information of the advertisement, information of the advertising transactions (price or the like), or information of the DSP 80). Here, the SSP 70 may insert information used for post-verification into the advertisement HTML transmitted from the DSP 80 to the terminal 10, or may insert information used for post-verification into different HTML transmitted from the DSP 80 to the terminal 10 (the different HTML is transmitted simultaneously with the advertisement HTML).

As illustrated in (E1) of FIG. 4A, the terminal 10 displays the delivery information (websites, articles, or the like) and the advertisement based on the HTML of the delivery information (websites, articles, or the like) including the advertisement tag received from the content server 20. Further, as illustrated in (E2) of FIG. 4A, the terminal 10 verifies that the delivery information (websites, articles, or the like) and the advertisement remain unchanged from those transmitted by the advertiser, i.e., the delivery information and the advertisement are not falsified.

Also, as illustrated in (F1) of FIG. 4A, in the RTB transactions, the SSP 70 (an example of “first transaction server”) attaches the OP-IDs of the media company and the SSP to a bid request, and the DSP 80 (an example of “second transaction server”) attaches the OP-IDs of the advertiser and the DSP to a bid response. As such, both parties confirm the OP-ID of the other party (or a signed originator profile (SOP) associated with the OP-ID) and then conduct transactions.

As illustrated in (G1) of FIG. 4A, for example, the advertiser provides the advertisement to the DSP 80 from the terminal or the like. Further, the advertiser server 40 allows the DSP 80, for example, to manage the ID and a private key of the advertiser on behalf of the advertiser.

The ad server 30 has a function of transmitting advertisement HTML. However, in the example illustrated in FIG. 4A, the DSP 80 is provided with this function, and thus illustration of the ad server 30 is omitted.

Each piece of information illustrated in FIG. 4A will be described.

Originator Profile-Identifier (OP-ID) The OP-ID is organization identification information for uniquely identifying an organization, such as an advertiser, a media company, an advertising intermediary (DSP or SSP), or the like, in the entire RTB transactions. For example, in response to a request from an organization, the OP-ID is issued by an originator profile collaborative innovation partnership (OP CIP) (an example of “predetermined certification institution”), which operates the management server 60. Issuance of the OP-ID is performed after the OP CIP confirms that the organization requesting the issuance of the OP-ID is in compliance with “originator profile charter” (OP charter), which defines basic principles of the OP and an operational system. When issuing an OP-ID, the OP CIP considers the matters listed in the following items 1-3, and examines whether or not it is reasonably indicated that this charter will be in compliance with. Therefore, an organization holding such an OP-ID can be regarded as an organization having high reliability. As used herein, the term “reliability” refers to: information transmission entities being in compliance with information transmission policies they created, as information transmission entities having responsibility toward democratic society; and information transmission entities having governance systems sufficient to realize their information transmission policies.

Item 1. The existence of an information transmission policy as referred to in Article 2.

Item 2. The availability of governance in accordance with the actual conditions of their industry and type of business.

Item 3. The nature of the trade association to which the entity belongs (if it is certified, the nature of its certification), or whether the entity is an organization that disseminates information in accordance with the basic principles referred to in Article 1 to the same extent as would an entity which belongs to a trade association for which its eligibility has been approved.

Here, Article 1 described in the above item 3, and Article 2 described in the above item 1 are as follows.

### Article 1: Basic Principles of OP

1. Through its dissemination, OP shall serve as an indicator for judging the authenticity and reliability of information and the entities that transmit it, thereby encouraging responsible behavior by businesses and others involved in information distribution and contributing to the realization of information recipients' right to know. In addition, its purpose is to support the construction of a healthy infosphere, contributing to the sound development of democracy, the maintenance of each person's life and health, and the protection of their bodies and property.
2. The term “authenticity” as used in this Charter means that the entity transmitting information under a certain distinguished name is the actual entity that bears that name, and that there has been no falsification of the content of the transmission.
3. The term “reliability” as used in this Charter means that the relevant entity transmitting information, as a responsible transmitter of information to a democratic society, follows the information transmission policy it has established according to the basic stance set forth in Article 2 below, and that it has governance sufficient to realize such policy.

### Article 2: Basic Stance of Entities Transmitting Information Using OP

1. Entities transmitting information using OP must develop and publish a policy for information transmission based on the following items:
   i. Respecting fundamental human rights.
   ii. Contributing to a just society based on democracy.
   iii. Emphasizing truthfulness and promptly correcting misinformation when it becomes clear that it has been transmitted.
   iv. Transmitting information with integrity so as not to manipulate or mislead consumers.
   v. Ensuring transparency in the use of generative AI.
2. Entities transmitting information using OP must strive to develop the governance necessary to ensure the effectiveness of the information transmission policy described in the preceding paragraph, in accordance with the actual conditions of their industry and type of business.
3. Mass media using OP must develop governance based on the fact that they have a great social responsibility for the transmission and distribution of information.

### Core Profile (CP)

The CP (an example of the first certificate or the third certificate in a delivery system or method for determining reliability of an advertisement; or an example of the first certificate in a delivery system or method for determining reliability of an article, a content providing system, or a service providing method) is a verifiable certificate issued using digital signature technology and including the OP-ID of an organization, such as an advertiser, a media company, an advertising intermediary (DSP or SSP), or the like, and a public key of the organization.

### Profile Annotation (PA)

The PA (an example of the first certificate or the third certificate in a delivery system or method for determining reliability of an advertisement; or an example of the first certificate in a delivery system or method for determining reliability of an article, a content providing system, or a service providing method) includes, for example: a verifiable certificate, issued using digital signature technology, that can verify that a third party certifies the existence of an organization, such as basic information and the like, e.g., a name, address, and the like of the organization; and a verifiable certificate of authentication, issued using digital signature technology, that shows that an organization belongs to a socially trusted trade association, such as KEIDANREN (Japan Business Federation) or the like, or has a system that implements ad fraud measures issued by a third-party certification institution, such as Japan Joint Industry Committee for Digital Advertising Quality & Qualify (JICDAQ) or the like, to its member organizations. Content of its description is created by an organization. For example, in response to a request from an organization, the PA is issued by an operator of the management server 60 in accordance with the results of confirmation of the content of the description performed, for example, by a trade association to which the organization belongs. That is, the PA is issued to an organization by a socially trusted trade association, certification association, or the like, which is examined and recognized by the OP CIP. Thus, the organization to which the PA is issued can be determined as an organization having “reliability of information” as defined above. Attribute information included in the PA may include, for example, an evaluation rank of the reliability of an organization as an example of information contributing to objective determination that further increases the “reliability” as defined above. The evaluation rank is determined by a public certification institution, and represents the degree of reliability of an organization stepwise. Thus, a verifier or the like of the PA can determine the degree of reliability of an organization based on the evaluation rank of the attribute information, and perform processing in accordance with the degree of reliability. Also, as another example of information contributing to determination of reliability, for example, the determination result of the presence or absence of reliability of an organization (i.e., a binary value, “present” or “absent”) may be included. Thus, a verifier or the like of the PA can determine the presence or absence of reliability of an organization, and perform processing in accordance with the presence or absence of reliability.

The attribute information included in the PA may include a plurality of annotation types that are defined classification names, such as the country of an organization, the corporate type, and the like (e.g., in the case of ABC Bank having the headquarters located in Japan, op.annotation_type.country.jp indicating an organization confirmed to exist in Japan, or op.annotation_type.company_type.bank indicating that the organization is a bank), and these can verify acquisition of third party's confirmation or certification. Also, a mapping table (see FIG. 4C) in which reference can be made to icons (the country and the corporate type) representing the meanings of the annotation types, which are necessary when information display software, such as a browser or the like, displays the PA information, may be integrated into the software, such as a browser or the like, or may be placed on a given Internet server. Note that security measures are taken such that any third party other than the organization holding the PA cannot rewrite this mapping table. Also, when information display software, such as a browser, a smartphone application, or the like, can acquire icon data from the PA through the mapping table in the PA information, the icons of the country, the corporate type, and the like indicated by the annotation types may be displayed in a display space of the software, such as a browser URL bar or the like. However, if it is impossible to verify whether or not third-party certification was achieved, an icon to be displayed is an icon indicating that verification is not achieved. Hovering a mouse over this icon displays a bubble indicating details of the meaning represented by the icon, and achievement of the verification may be displayed here.

FIG. 4C is a diagram illustrating a display example of icons included in a PA displayed by the advertisement delivery system 1 according to the first embodiment. For example, as illustrated in FIG. 4C, by visually displaying these icons in an appropriate display space of information display software, such as a browser URL bar or the like, it is possible to allow these icons to be helpful for determination of a fake site. For example, when a user accesses a fake site that purports to be a famous bank in Japan or the United States, the design of the site can be replicated, but it is impossible to display icons in a browser, an application, and the like after acquiring third-party certification of the country or corporate type. Therefore, the user can utilize, as a material for determining a fake site, whether or not the icons displayed in the browser, the application, and the like match the content of a displayed site. Note that, as a premise, any third party (an entity transmitting information, such as a website or the like) other than the software development manufacturer cannot display the icons.

Advertisement Content Attestation (CA) Advertisement CA (an example of the second certificate or the fourth certificate in a delivery system or method for determining reliability of an advertisement; or an example of the second certificate in a content providing system or a service providing method) is a verifiable certificate using digital signature technology that shows that an advertisement remains unchanged from that delivered by an advertiser, i.e., the advertisement is not falsified. The advertisement CA includes data, signed by a CP holder, that describes information about an identification or verification method or the like for information about web content or the like, and for the target content. Also, site CA includes a content attestation identifier (CA-ID), which is identification information for uniquely identifying an advertisement. The advertisement CA is included in a hidden area of the advertisement HTML to enable a viewer or the like of a web content site to confirm that the advertisement and the advertiser are correct. The advertisement CA is created by the advertiser or an agency, and issued by the advertiser, an agency, or DSP through a digital signature process. That is, when the advertisement CA is verified along with the advertiser's CP and PA, which certify that the advertiser is reliable, the advertisement to which the advertisement CA is issued can be regarded as a reliable advertisement.

### Article Content Attestation (CA)

The article CA (an example of the second certificate in a delivery system or method for determining reliability of an article) is a verifiable certificate, issued using digital signature technology, that shows that an article remains unchanged from that delivered by an article transmission entity, i.e., the article is not falsified. The article CA includes: OP-ID of an article provider (a source of provision of an article); CA-ID, which is identification information of an article; and attribute information of an article. The article CA enables a viewer or the like of the article to confirm that the article and the article provider are correct. The article CA is created and signed by the article provider, and issued by the article provider. That is, the article CA includes the OP-ID of the article provider certifying reliability, and thus the article to which the article CA is issued can be regarded as a reliable article.

The CP, SP, advertisement CA, article CA, and PA are all in compliance with a data model of verifiable credential (VC) (an example of a data model of an issuer holder verifier (IHV)). Thus, an inquiry to the management server 60 or the like does not occur every time of verification, thereby achieving a system free of an increase in server load, privacy issues, and the like. Here, the CP, SP, advertisement CA, article CA, and PA are not limited to those in compliance with the data model of VC as long as they are in compliance with those in the data model of the IHV. The CP, SP, advertisement CA, article CA, and PA may be those in compliance with a data model other than VC, such as those in compliance with a data model similar to the data model of VC. Note that the IHV is a verification model in which an issuer, a holder, and a verifier are involved.

The web content refers to general digital content delivered from the content server 20. Examples of the web content include, for example, a web page and portions of the web page, such as an article, an image, a moving image, and the like.

### (Example of Procedure of Advertisement Delivery Process)

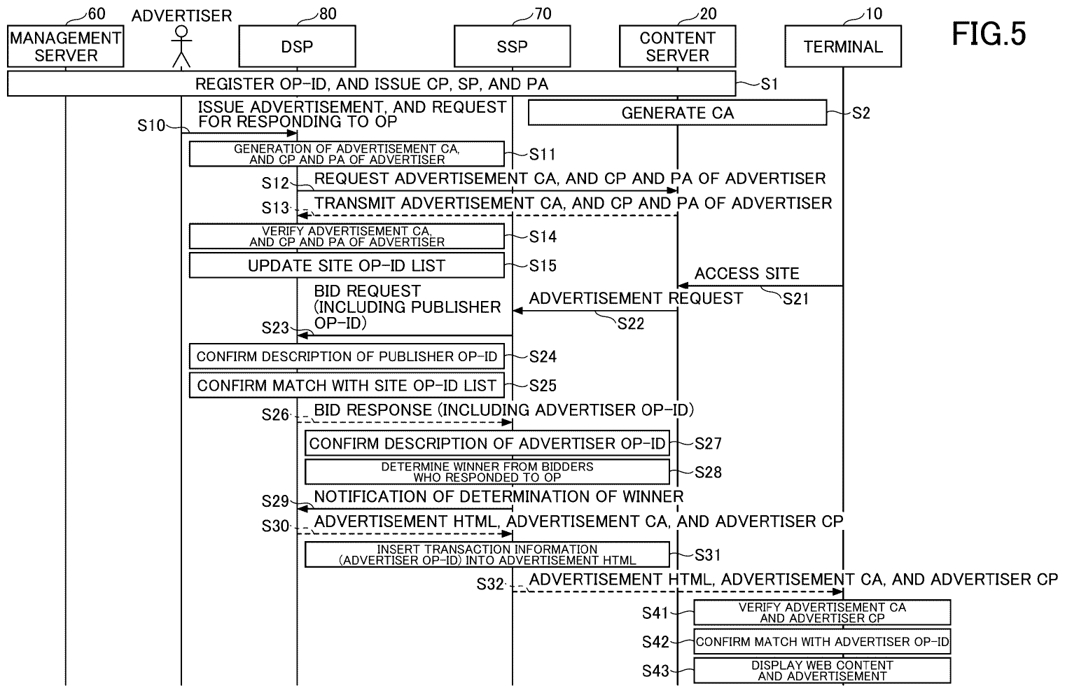

FIG. 5 is a sequence diagram illustrating an example of a procedure of an advertisement delivery process performed by the advertisement delivery system 1 according to the first embodiment.

### <Prerequisite Process>

First, a prerequisite process (steps S1 and S2) will be described.

In the prerequisite process, first, the management server 60 registers an OP-ID and issues CP, SP, and PA to each organization (advertisers, media companies, advertising intermediaries (DSP and SSP), or the like) (step S1). As illustrated in FIG. 4B, the CP includes a certificate signed with a signing key of the OP CIP, a public key of each organization, and reference information of a public key of the OP CIP in order to certify that an organization is a CP issuer. The SP includes a certificate signed with a signing key of the organization and reference information of a public key for the signing key in order to certify that a site is of the organization. The PA includes a certificate signed with a signing key of a third-party institution and reference information of a public key for the signing key in order to certify that, for example, the organization belongs to issuing organizations.

Next, the content server 20 generates CA, which is a verifiable certificate indicating that content is not falsified, while retaining the CP, SP, and PA (step S2). As illustrated in FIG. 4B, the CA includes a signature of the content publisher and reference information of a public key of the publisher included in the CP in order to certify that the content is of the publisher.

### <Preliminary Process>

Next, a preliminary process (steps S10 to S15) will be described.

In the preliminary process, first, an advertiser issues an advertisement to the DSP 80 and requests the DSP 80 for responding to its OP (step S10).

Next, the DSP 80 generates advertisement CA of the advertisement and the CP and PA of the advertiser of the advertisement (step S11). In step S11, as in step S2, the advertisement CA includes, as reference information, information sufficient to find a public key of the issuer in order to verify that the content is of the issuer.

Next, the DSP 80 requests the content server 20 for the advertisement CA of the advertisement and for the CP and PA of the advertiser of the advertisement (step S12). In response to this request, the content server 20 transmits, to the advertiser server 40 (DSP), the advertisement CA of the advertisement and the CP and PA of the advertiser of the advertisement (step S13).

Next, the DSP 80 verifies the advertisement CA of the advertisement and the CP and PA of the advertiser of the advertisement received from the content server 20 (step S14).

For example, the DSP 80 acquires a public key for CP verification from the management server 60 (i.e., a certification institution), and uses the acquired public key for CP verification to verify the signatures of the CP, PA, CA, and SP of a media company providing a website included in the OP, thereby confirming the reliability of the media company providing the website.

The DSP 80 may previously acquire the public key for CP verification from the management server 60, and store the acquired public key in a memory or the like. In this case, when verifying CP, PA, CA, and SP, the DSP 80 can read out the public key for verification of CP, PA, CA, and SP from the memory or the like to acquire the public key for verification of CP, PA, CA, and SP.

Also, for example, the DSP 80 acquires a public key for CA verification from the verified CP, and uses the acquired public key for CA verification to verify the signature of CA of a website included in the CA, thereby confirming that the website is not falsified.

The DSP 80 may acquire the public key for CA verification from the management server 60 (i.e., a certification institution).

Next, the DSP 80 updates an OP-ID list, which is a list of correct combinations of websites and website operators (OP-IDs) (step S15). The DSP 80 may be set not to update the OP-ID list (i.e., not to include the combinations of websites and website operators (OP-IDs)) when either or both of: the verification of the signature of the CP and PA of the advertiser; and the verification of the signature of the SP of the website fail in step S14.

Also, in step S14, the DSP 80 may confirm content of the description of attribute information included in the PA of the website operator, thereby determining whether or not the CP and OP-ID of the website operator are reliable based on the content of the description of the attribute information. In this case, the DSP 80 may update the OP-ID list when determining that the CP and OP-ID of the website operator are reliable, and the DSP 80 need not update the OP-ID list when determining that they are not reliable.

Through the above preliminary process, the DSP 80 can verify whether or not the combinations of the websites and the website operators are correct before an RTB transaction process is performed. That is, the above preliminary process eliminates a need to perform similar verification in the RTB transaction process, thereby enabling reduction in a processing load of the RTB transaction process.

### <RTB Transaction Process>

Next, the RTB transaction process (steps S21 to S32) will be described.

In the RTB transaction process, first, the terminal 10 accesses a given website (step S21). Specifically, the transmission/reception unit 13 of the terminal 10 transmits, to the content server 20, a request to acquire web content provided by a specific media company (i.e., web content randomly designated by a viewer).

Next, the transmission/reception unit 22 of the content server 20 transmits, to the SSP 70, an advertisement request for the web content (step S22).

Next, the transmission/reception unit 72 of the SSP 70 transmits, to the DSP 80, a bid request for an advertisement for the web content based on the information received from the content server 20 (step S23). The transmission/reception unit 72 of the SSP 70 includes, in the bid request, the OP-ID of the media company providing the web content. Also, the transmission/reception unit 72 of the SSP 70 may include, in the bid request, the CP of the web content and the CA of the web content.

The SSP 70 may determine whether or not to permit the DSP 80 to provide the advertisement for the web content, for example, based on the CP of the provider of the web content. Thus, for example, the entity of the DSP 80 can avoid providing the advertisement for the content that is provided by an entity not having a predetermined CP certified by a third-party institution or the like.

In this case, for example, the SSP 70 may determine the presence or absence of the CP and PA of the web content, and when the SSP 70 does not receive the CP and PA from the content server 20, the SSP 70 may reject the DSP 80 providing the advertisement. Also, for example, the SSP 70 may determine conditions, such as, for example, whether or not the PA includes information of a predetermined item, such as an address or the like, and when the information of the predetermined item is not included, the SSP 70 may reject the DSP 80 providing the advertisement. Thus, when the provider of the content is not certified, provision of the advertisement can be avoided. This is considered to reduce provision of the advertisement on media, such as websites, SNS, and the like, which provide inappropriate content, e.g., fake news, content that infringes another person's copyright, content including personal information, and the like.

Also, the SSP 70 may determine whether or not to permit the DSP 80 to provide the advertisement for the web content, for example, based on the CA indicating that the web content is not falsified. Thus, the entity of the DSP 80 can allow the SSP 70 to be previously designated about, for example, attributes of content to which the advertisement is to be provided. In this case, for example, conditions of the CA of web content to accept a bid request that are designated by the entity of the DSP 80 may be previously registered in the SSP 70. Then, the SSP 70 may determine whether or not information included in the CA indicating that the web content is not falsified fulfills the conditions designated by the entity of the DSP 80. In this case, the SSP 70 determines conditions, such as, for example, whether or not the attributes or the like of the web content included in the CA match the attributes or the like of the web content designated by the entity of the DSP 80, and when they do not match each other, the SSP 70 may reject the DSP 80 providing the advertisement.

Next, the control unit 83 of the DSP 80 confirms whether or not the OP-ID of the media company is included in the bid request received from the SSP 70 (step S24).

Also, the control unit 83 of the DSP 80 confirms whether or not the OP-ID of the media company included in the bid request received from the SSP 70 matches the list of OP-IDs of the site (i.e., whether or not it is a reliable OP-ID) (step S25).

Here, like in the process performed by the SSP 70, the DSP 80 may determine, for example, whether or not to permit provision of the advertisement for the web content based on: the PA indicating various attribute information, certified by a third party, of a provider of web content; the CA indicating that the web content is not falsified; and the conditions previously determined by the entity of the DSP 80. Only when the DSP 80 determines permission of provision of the advertisement for the web content, the DSP 80 may transmit (return), to the SSP 70, a response to the bid request for the advertisement for the web content. Thus, the entity of the DSP 80 can determine whether or not to permit provision of the advertisement on the DSP 80 side. The determination of whether or not to provide the advertisement may be performed by only one of the SSP 70 or the DSP 80.

Also, for example, the DSP 80 may determine a bid amount for the advertisement for the web content based on: the PA indicating various attribute information, certified by a third party, of web content; and the CA indicating that the web content is not falsified. In this case, for example, the DSP 80 may determine the bid amount based on the information of the entity of the content server 20, the attributes of the web content, the type of the generation method of the web content, and the like. In this case, for example, the DSP 80 may determine the bid amount to be relatively high when the entity of the content server 20 is famous, the attribute of the web content is economic news, and the type of the generation method of the web content is an interview. Therefore, for example, the entity of the DSP 80 can support the issuance of content that is considered to have, for example, a high degree of appropriateness, a high degree of expertise, and a relatively large amount of labor required to generate the content.

Also, for example, the DSP 80 may determine the advertisement to be provided for the web content based on: the PA indicating various attribute information, certified by a third party, of web content; and the CA indicating that the web content is not falsified.

Next, the transmission/reception unit 82 of the DSP 80 transmits a bid response to the SSP 70 (step S26). The transmission/reception unit 82 of the DSP 80 includes, in the bid response, the OP-ID of the advertiser who is a bidder.

Subsequently, the control unit 73 of the SSP 70 confirms whether or not the OP-ID of the advertiser who is the bidder is included in the bid response received from the DSP 80 (step S27).

Then, the control unit 73 of the SSP 70 determines a successful bidder (i.e., the winner) from a plurality of bidders based on the bid response received from the DSP 80 (step S28). Here, for example, the control unit 73 of the SSP 70 may determine, as the successful bidder, the advertiser providing the highest bid amount. Also, the control unit 73 of the SSP 70 may determine the successful bid amount (advertising fees) to be recovered from the entity of the DSP 80 determined as the successful bidder, for example, based on the highest bid amount or the second highest bid amount.

Subsequently, the transmission/reception unit 72 of the SSP 70 transmits a winner determination notice to the DSP 80 for notification of being the successful bidder (i.e., the winner) (step S29).

The transmission/reception unit 82 of the DSP 80 transmits, to the SSP 70, the HTML of the advertisement, the CA of the advertisement content, and the advertiser CP, in response to receiving the winner determination notice from the ad server 30 (SSP) (step S30).

Then, the control unit 73 of the SSP 70 attaches information used for post-verification (e.g., the OP-ID of the advertiser) to the HTML of the advertisement received from the DSP 80 (step S31). Here, the information attached to the HTML of the advertisement is not limited to the OP-ID of the advertiser, and may include any other information as long as it is verifiable in a post-process described below.

Subsequently, the transmission/reception unit 72 of the SSP 70 transmits, to the terminal 10 of the viewer, the HTML of the advertisement attached with the information used for post-verification, and the CA of the advertisement content and the advertiser CP received from the DSP 80 (step S32).

### <Post-Process>

Next, a post-process (steps S41 and S42) will be described.

In the post-process, first, the control unit 14 of the terminal 10 verifies the CA of the advertisement content and the advertiser CP received from the SSP 70 (step S41).

For example, the control unit 14 of the terminal 10 acquires a public key for CP verification from the management server 60 (i.e., a certification institution) to verify the signatures of the advertiser CP and PA included in the advertisement CP and PA using the acquired public key for CP verification, thereby confirming that the advertiser has reliability.

The terminal 10 may previously acquire the public key for CP verification from the management server 60, and store the acquired public key in a memory or the like. In this case, when verifying CP and PA, the control unit 14 of the terminal 10 can read out the public key for verification of CP and PA from the memory or the like to acquire the public key for verification of CP and PA.

Also, for example, the control unit 14 of the terminal 10 acquires a public key for CA verification from the verified CP and PA, and uses the acquired public key for CA verification to verify the signature of advertisement CA included in the CA, thereby confirming that the advertisement has reliability.

The control unit 14 of the terminal 10 may acquire the public key for CA verification from the management server 60 (i.e., a certification institution).

Subsequently, the control unit 14 of the terminal 10 confirms whether or not the OP-ID of the advertiser included in the information used for post-verification attached to the HTML of the advertisement received from the SSP 70 matches the OP-ID of the advertiser included in the CA of the advertisement content and the CP of the advertiser (step S42). Thus, the control unit 14 of the terminal 10 confirms that the advertiser is highly reliable.

Through the above-described post-process, the terminal 10 can verify whether or not the advertisement and the advertiser are reliable after the RTB transaction process is performed. That is, the above post-process eliminates a need to perform similar verification in the RTB transaction process, thereby enabling reduction in a processing load of the RTB transaction process. The information to be verified in the post-process is not limited to the OP-ID of the advertiser, and may include any other information.

Subsequently, the control unit 14 of the terminal 10 displays the web content and the advertisement on a screen (step S43).

Here, the control unit 14 of the terminal 10 may display information indicating the reliability of at least one of the website, the media company providing the website, the advertiser, or the advertisement.

Also, for example, in response to a predetermined operation performed by a user, the control unit 14 of the terminal 10 may display information included in CP, PA, CA, and SP of at least one of the website, the media company providing the website, the advertiser, or the advertisement.

For example, the control unit 14 of the terminal 10 may display a name, address, e-mail address, evaluation score, and the like, as information included in the PA of the media company providing the website and the PA of the advertiser.

For example, the control unit 14 of the terminal 10 may display the OP-ID of the advertiser, and the title, description, thumbnail, and the like of the advertisement, as information included in the CA of the advertisement.

Also, for example, the control unit 14 of the terminal 10 may display the OP-ID of the operator of the website, and the site name, description, operator's logo, and the like, as information included in the SP of the website.

The terminal 10 may be set to perform predetermined error processing (e.g., to avoid displaying an advertisement, or to display a message indicating that reliability of the advertisement is low) when either or both of: the verification of the signature of the CP of the advertiser; and the verification of the signature of the CA of the advertisement fail in step S41 (a verification process of an advertisement profile pair).

Also, the terminal 10 may be set to perform predetermined error processing (e.g., to avoid displaying an advertisement, or to display a message indicating that reliability of the advertisement is low) when the OP-ID of the advertiser inserted into the HTML of the advertisement does not match the OP-ID of the advertiser included in the CA of the advertisement content and the CP of the advertiser in step S42 (a verification process for confirming whether or not the OP-IDs match each other).

Also, for example, the control unit 14 of the terminal 10 may notify a predetermined information processing device (e.g., the SSP 70, the DSP 80, any other server, or the like) of invalidation of advertising transactions in order to avoid charging the advertiser when the advertisement is not displayed as part of the predetermined error processing.

Also, in the above example, the control unit 14 of the terminal 10 performs the process of displaying the web content and the advertisement (step S43) after step S41 (the verification process of CP and CA) and step S42 (the verification process for confirming whether or not the OP-IDs match each other). However, this is by no means a limitation. For example, the process of displaying the web content and the advertisement may be performed before steps S41 and S42.

In the advertisement delivery system 1, the log server 50 may store log information of the RTB transactions described above. In this case, the log information may include the execution results of the verification processes of the OP-ID, CP, PA, CA, SP, and the like. Thus, for example, the advertisement delivery system 1 can certify whether or not the correct advertisement has been delivered from the correct advertiser based on the transaction information stored in the log server 50.

### Second Embodiment

Next, a second embodiment of the present disclosure will be described. In the second embodiment, the OP-ID, CP, and PA are issued to organizations, such as companies, municipalities, media, platforms (e.g., search engines or social media), and the like, and article information (e.g., a specific article on a website) delivered from these organizations is allowed to include the OP-ID of the distributor, CP and PA of the distributor, CA of the article, and the like, thereby confirming the truthfulness of the article and the article distributor and preventing the spread of fake news and the like.

### (Examples of Various Types of Information)

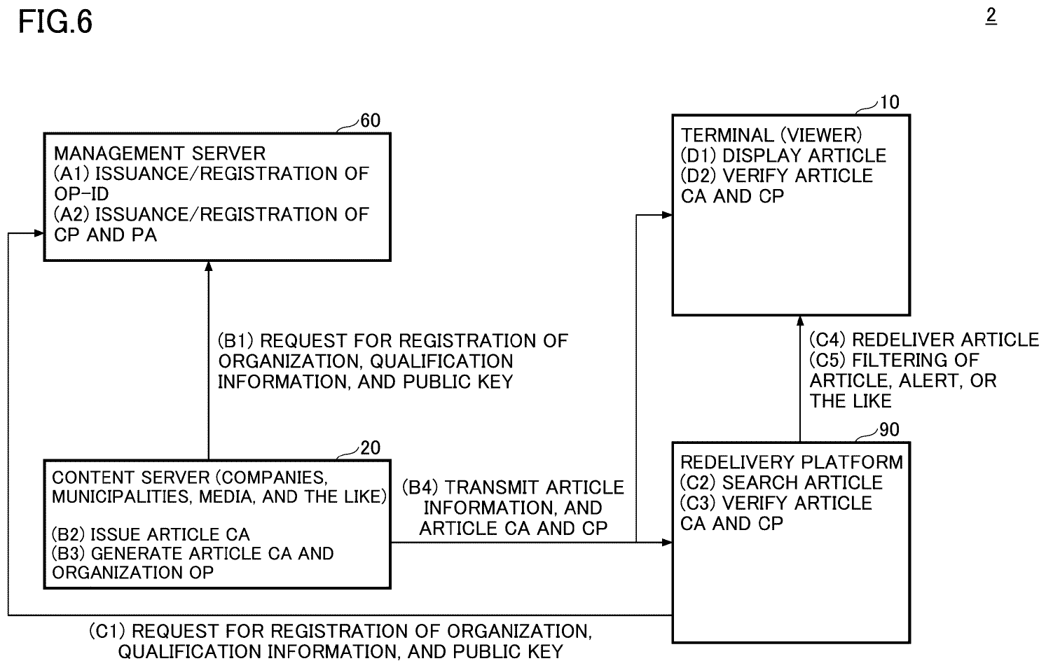

FIG. 6 is a diagram illustrating examples of various types of information handled by an article delivery system 2 according to the second embodiment. As illustrated in FIG. 6, the article delivery system 2 according to the second embodiment includes the management server 60, the content server 20, a redelivery platform 90, and the terminal 10.

The content server 20 is a server operated by an organization that delivers an article (hereinafter may be referred to as “article delivery organization”). The content server 20 delivers the article to the terminal 10 or the redelivery platform 90 in response to an article acquisition request from the terminal 10 or the redelivery platform 90.

The redelivery platform 90 is a search engine, social media, or the like that acquires an article from the content server 20, and redelivers the article to the terminal 10. For example, the redelivery platform 90 is implemented by one or more servers.

The terminal 10 is a device used by a viewer of an article. The terminal 10 receives the article delivered or redelivered from the content server 20 or the redelivery platform 90 in response to the article acquisition request to the content server 20 or the redelivery platform 90, thereby displaying the article.

As in the first embodiment, the management server 60 is a device that functions as an “originator profile (OP) registry”, which manages various types of information (OP-ID, CP, PA, SP, and CA) of the reliability of organizations (companies, municipalities, media, platforms, and the like), articles, and the like. The management server 60 is operated by a predetermined public certification institution that certifies organizations, articles, and the like.

As illustrated in (A1) of FIG. 6, for each organization (companies, municipalities, media, platforms, and the like), the management server 60 issues an originator profile OP-ID, which is an ID of the organization, and registers the OP-ID in the system.

As illustrated in (A2) of FIG. 6, for each organization (companies, municipalities, media, platforms, and the like), the management server 60 issues CP and PA, which are certificates of an organization profile of the organization, and registers the CP and PA in the system.

For example, in response to a request from an organization operating the content server 20 (see (B1) of FIG. 6), the management server 60 issues an OP-ID and CP of the organization.

Also, for example, in response to a request from the redelivery platform 90 (see (C1) of FIG. 6), the management server 60 issues an OP-ID and CP of the redelivery platform 90.

Also, as illustrated in (B2) of FIG. 6, for each piece of article information, the content server 20 issues an article CA, which is a certificate enabling verification that the article information is not falsified.

Also, as illustrated in (B3) of FIG. 6, for each piece of article information, the content server 20 generates the article CA (issued by the content server 20), which is a certificate enabling verification that the article information is not falsified, and CP (issued by the management server 60) of the organization that delivers the article information.

As illustrated in (B4) of FIG. 6, in response to a request for an article from the terminal 10 or the redelivery platform 90, the content server 20 delivers article information (e.g., HTML) to the terminal 10 or the redelivery platform 90. The content server 20 includes, in the article information, the article CA and CP of the article information.

Some of the functions of the content server 20 illustrated in FIG. 6 (e.g., generation and management of the article CA) may be implemented by a device (e.g., a content management system (CMS)) that is provided outside the content server 20.

Also, as illustrated in (C2) of FIG. 6, in response to a request from the terminal 10, the redelivery platform 90 searches for article information and receives the article information from the content server 20. Also, as illustrated in (C3) of FIG. 6, the redelivery platform 90 verifies the article CA and CP included in the article information received from the content server 20.

For example, a control unit of the redelivery platform 90 can acquire a public key for CP verification from the management server 60 (i.e., a certification institution) to verify the signatures of the CA and CP of an organization that is a source of delivery of article information (hereinafter may be referred to as “article information delivery source organization”) included in the article CA using the acquired public key for CP verification, thereby confirming that the article information delivery source organization has reliability.

The redelivery platform 90 may previously acquire the public key for CP verification from the management server 60, and store the acquired public key in a memory or the like. In this case, when verifying CP, the control unit of the redelivery platform 90 can read out the public key for CP verification from the memory or the like to acquire the public key for CP verification.

Also, for example, the control unit of the redelivery platform 90 acquires a public key for CA verification from the verified CP, and uses the acquired public key for CA verification to verify the signature of article CA included in the article CA and CP, thereby confirming that the article has reliability.

The control unit of the redelivery platform 90 may acquire the public key for CA verification from the management server 60 (i.e., a certification institution).

As illustrated in (C4) of FIG. 6, the redelivery platform 90 redelivers, to the terminal 10, the article information received from the content server 20. At this time, as illustrated in (C5) of FIG. 6, in accordance with the verification results of the article CA and CP, the redelivery platform 90 can perform filtering of the article, alerting, or the like. Also, at this time, the redelivery platform 90 may include the CP of the redelivery platform 90 in the article to be redelivered to the terminal 10.

As illustrated in (D1) of FIG. 6, the terminal 10 displays article information based on the HTML of the article information received from the content server 20 or the redelivery platform 90. Also, as illustrated in (D2) of FIG. 6, the terminal 10 verifies the article CA and CP included in the article information received from the content server 20 or the redelivery platform 90.

For example, the control unit 14 of the terminal 10 acquires a public key for CP verification from the management server 60 (i.e., a certification institution), and uses the acquired public key for CP verification to verify the signature of the CP of the article information delivery source organization included in the article CA and CP, thereby confirming that the article information delivery source organization has reliability.

The terminal 10 may previously acquire the public key for CP verification from the management server 60, and store the acquired public key in a memory or the like. In this case, when verifying CP, the control unit 14 of the terminal 10 can read out the public key for CP verification from the memory or the like to acquire the public key for CP verification.

Also, for example, the control unit 14 of the terminal 10 acquires a public key for CA verification from the verified CP, and uses the acquired public key for CA verification to verify the signature of article CA included in the article CA and CP, thereby confirming that the article has reliability.

The control unit 14 of the terminal 10 may acquire the public key for CA verification from the management server 60 (i.e., a certification institution).

As described above, according to the article delivery system 2 according to the second embodiment, it is possible to include in, the article delivered from the content server 20 to the terminal 10, the CP and PA of the article distributor certified by a predetermined public certification institution, the CA of the article certified by the article distributor that the article is not falsified, and the like. Thus, the article delivery system 2 according to the second embodiment can confirm the reliability of the article and the article distributor in the terminal 10 that received the article. Then, in the terminal 10, it is possible to perform processing in accordance with the confirmation results of the reliability of the article and the article distributor.

For example, the terminal 10 can confirm the reliability of the article distributor based on the CP and PA of the article distributor attached to the article. Alternatively, for example, the terminal 10 can confirm the reliability of the article distributor by verifying the CP and PA of the article distributor attached to the article.

Also, for example, the terminal 10 can confirm that the article is not falsified based on the article CA attached to the article. Alternatively, for example, the terminal 10 can confirm that the article is not falsified by verifying the article CA attached to the article.

Also, for example, the terminal 10 may be set to perform predetermined error processing (e.g., avoiding displaying an article, or displaying a message indicating that reliability of the article is low) when either or both of: the CP and PA of the article distributor; and the article CA are not attached to the article received from the content server 20 or the redelivery platform 90, or when the verification of either or both of: the CP and PA of the article distributor; and the article CA fails in the article received from the content server 20 or the redelivery platform 90.

In the article delivery system 2 according to the second embodiment, the terminal 10 may be set to confirm the reliability of the redelivery platform 90 using the CP and PA of the redelivery platform 90.

For example, upon receiving an article from the redelivery platform 90, the terminal 10 may confirm and verify the CP and PA of the redelivery platform 90 attached to the article. In this case, the terminal 10 may be set to perform predetermined error processing (e.g., avoiding displaying an article, or displaying a message indicating that reliability of the CP of the redelivery platform 90 is absent) when the CP and PA of the redelivery platform 90 are not attached to the article received from the redelivery platform 90 or when the verification of the CP and PA of the redelivery platform 90 fails in the article received from the redelivery platform 90.

Also, for example, upon receiving a request for an article from the redelivery platform 90, the content server 20 may confirm and verify the CP and PA of the redelivery platform 90 attached to the request for the article. In this case, the content server 20 may be set to perform predetermined error processing (e.g., avoiding providing an article) when the CP and PA of the redelivery platform 90 are not attached to the request for the article received from the redelivery platform 90 or when the verification of the CP and PA of the redelivery platform 90 fails in the request for the article received from the redelivery platform 90.

In the article delivery system 2 according to the second embodiment, the redelivery platform 90 may perform a process to confirm that the article is not falsified and a process to confirm the reliability of the article distributor, in the same manner as in the terminal 10.

For example, the redelivery platform 90 may be set to perform predetermined error processing (e.g., avoiding redelivery of an article to the terminal 10, or providing the terminal 10 with an alert for indicating that reliability of the article is absent) when either or both of: the CP and PA of the article distributor; and the article CA are not attached to the article received from the content server 20, or when the verification of either or both of: the CP and PA of the article distributor; and the article CA fails in the article received from the content server 20.

In the same manner as in the first embodiment, the article delivery system 2 according to the second embodiment may be provided with the log server 50, and the log server 50 may store delivery log information of an article from the content server 20, delivery log information of an article from the redelivery platform 90, and the like. At this time, the delivery log information of the article may include information, such as the OP-ID, CP, PA, CA, SP, distributor, delivery destination, and date and time of delivery of an article, and the like. Thus, for example, the article delivery system 2 can trace an article distributor (the content server 20), an intermediary (the redelivery platform 90), and a recipient (the terminal 10) based on these pieces of delivery log information.

### Third Embodiment

Next, a third embodiment of the present disclosure will be described. The third embodiment is related to a content providing system 3 that provides web content to web users. Specifically, in the content providing system 3, the web content is attached with: CP of a content provider; PA, which is a certificate, issued using digital signature technology, that enables verification of organization information and attribute information (e.g., certification, permission, and authorization) certified by a trade association; and CA, which is a certificate, issued using digital signature technology, that can verify that the content is not falsified. These CP, PA, and CA are used for a specific service (e.g., a point return service) associated with the web content, thereby improving the service.

### (Example of Service Providing Procedure Performed by Content Providing System 3)

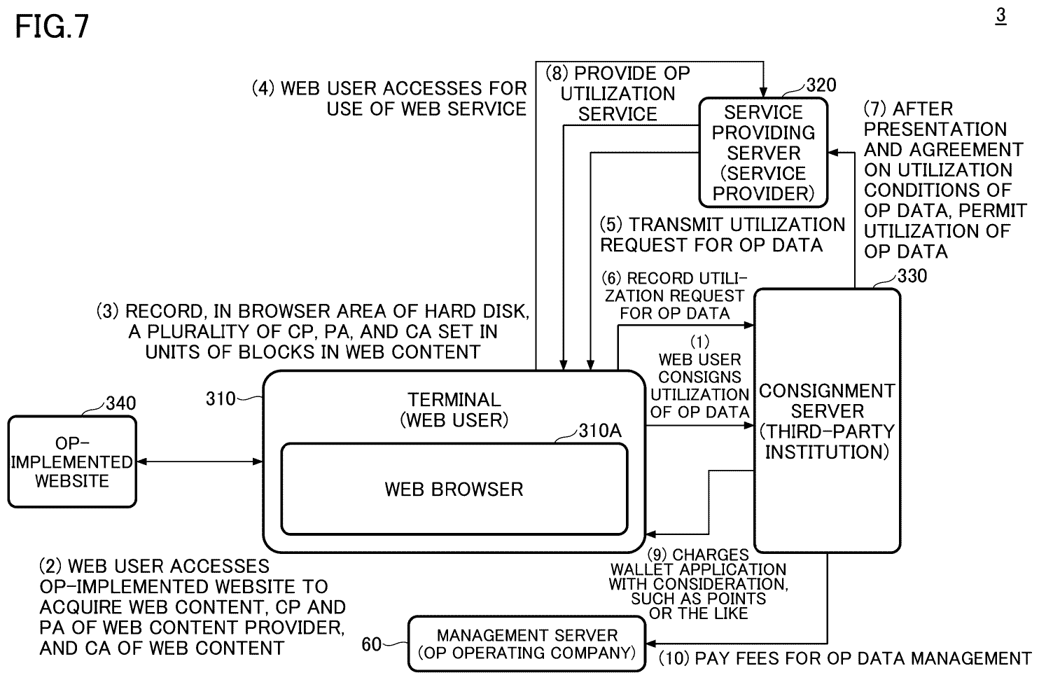

FIG. 7 is a diagram illustrating an example of a service providing procedure performed by the content providing system 3 according to the third embodiment.

In the content providing system 3 illustrated in FIG. 7, a service providing server 320 is operated by a service provider, and is a server, such as a publisher, a platform, or the like, that provides a predetermined web service to web users. For example, the service providing server 320 is implemented by one or more servers.

First, as a premise, it is assumed that relevant parties (web users, web browser vendors, service providers, OP operating companies, and third-party institutions consigned for utilization of OP) have agreed on utilization conditions for OP data (CP, PA, CA, and SP).

First, as illustrated in (1) of FIG. 7, a web user consigns utilization of OP data from a terminal 310 to a consignment server 330 (point platform or the like) operated by a third-party institution consigned for utilization of OP data.

Next, as illustrated in (2) of FIG. 7, a web user accesses an OP-implemented website 340 of a content server (not shown) from the terminal 310 to acquire web content, CP and PA of a web content provider, and CA of the web content. In the web content acquired from the OP-implemented website 340, CP and CA are set for each block, such as an article, a photograph, a moving image, or the like.

Next, as illustrated in (3) of FIG. 7, a web browser 310A of the terminal 310 records a plurality of CP, PA, and CA set for each block in the web content acquired in (2) of FIG. 7 in a browser area of a hard disk included in the terminal 310 as browsing log information of the web content (a web page and portions of the web page, such as an article, an image, a moving image, and the like) browsed by the web user. Here, the terminal 310 may record a plurality of CP, PA, and CA in the consignment server 330 as browsing log information of the web content (a web page and portions of the web page, such as an article, an image, a moving image, and the like) browsed by the web user.

Next, as illustrated in (4) of FIG. 7, the web user accesses the service providing server 320 using the terminal 310 (e.g., a PC or a smartphone) in order to utilize a desired web service.

Next, as illustrated in (5) of FIG. 7, the service providing server 320 transmits, to the terminal 310 used by the web user, a request to utilize the OP data (CP, PA, CA, and SP) for improving the service.

Next, as illustrated in (6) of FIG. 7, the web browser 310A of the terminal 310 notifies the web user of the request to utilize the OP data (CP, PA, CA, and SP), and then records the request to utilize the OP data (CP, PA, CA, and SP) in the consignment server 330.

Next, as illustrated in (7) of FIG. 7, the consignment server 330 permits the service provider to utilize the OP data (CP, PA, CA, and SP) after presentation and agreement on the utilization conditions for the OP data (CP, PA, CA, and SP).

Next, as illustrated in (8) of FIG. 7, the service providing server 320 provides a service utilizing the OP data (CP, PA, CA, and SP) to the terminal 310 used by the web user.

Next, as illustrated in (9) of FIG. 7, the consignment server 330 charges a wallet application of the terminal 310 with consideration, such as points or the like, based on the utilization conditions after deduction of necessary fees.

Next, as illustrated in (10) of FIG. 7, the consignment server 330 pays management fees for the OP data to an OP operating company.

As described above, according to the content providing system 3 according to the third embodiment, the reliability of the web content acquired by the web user can be increased by attaching OP data (CP, PA, CA, and SP) or the like to the web content acquired by the web user.

Also, according to the content providing system 3 according to the third embodiment, a plurality of OP profile sets acquired in the past by the terminal 310 from the OP-implemented website 340 can be recorded in the terminal 310, the consignment server 330, or the like, as the browsing log information of the web content (a web page and portions of the web page, such as an article, an image, a moving image, and the like) browsed by the web user. When the browsing log information of the web content is analyzed by the terminal 310, the consignment server 330, or the like, it is possible to generate OP user information indicating user's hobbies, preferences, attributes, and the like. In this case, for example, the terminal 310 or the consignment server 330 may provide the OP user information to the service providing server 320 automatically or in accordance with instructions of the web user, and the service providing server 320 may narrow down services to be provided to the web user based on the provided OP user information such that appropriate services are provided to the web user. The OP user information provided to the service providing server 320 may be automatically generated by the terminal 310, the consignment server 330, or the like through an analysis process, or may be manually generated by the web user operating the terminal 310.

The content providing system 3 according to the third embodiment may be configured not to include the consignment server 330. In this case, the process to be performed between the consignment server 330 and the service providing server 320 may be performed between the terminal 310 (web user) and the service providing server 320.

Also, in the content providing system 3 according to the third embodiment, the management server 60 may issue the OP-ID, CP, and PA to the consignment server 330 (third-party institution), and when processing is performed between the consignment server 330 and the service providing server 320, the service providing server 320 may determine the reliability of the consignment server 330 (third-party institution). Also, in this case, when processing is performed between the terminal 310 (web user) and the consignment server 330 (third-party institution), the terminal 310 (web user) may determine the reliability of the consignment server 330 (third-party institution).

### Fourth Embodiment

Next, a fourth embodiment of the present disclosure will be described. The fourth embodiment is related to a generative AI system. In the generative AI system, OP-ID, CP, and PA are issued to an article delivery organization (companies, municipalities, media, or the like) and a generative AI company, and CA, which is a certificate, issued using digital signature technology, that can verify that the article is not falsified is attached to the article information (i.e., training data) delivered from the organization and used by the generative AI company for training, thereby increasing the reliability of the article distributor, the generative AI company, and the training data.

### (Examples of Various Types of Information)

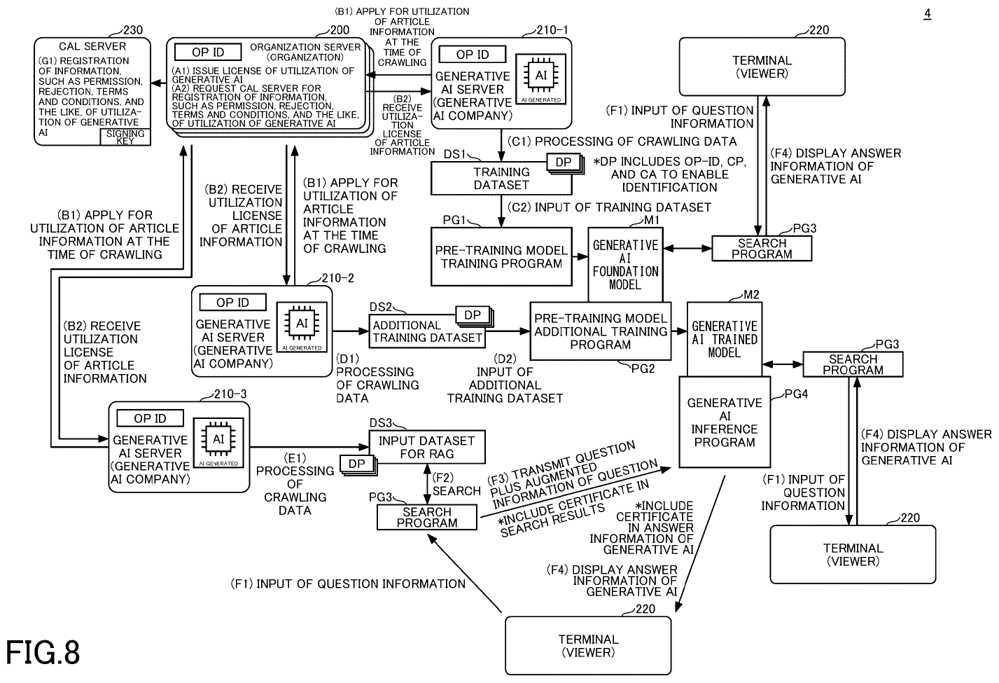

FIG. 8 is a diagram illustrating examples of various types of information handled by a generative AI system 4 according to the fourth embodiment. As illustrated in FIG. 8, the generative AI system 4 according to the fourth embodiment includes a plurality of organization servers 200, generative AI servers 210-1, 210-2, and 210-3, a terminal 220, and a content attestation ledger (CAL) server 230.

The generative AI system 4 according to the fourth embodiment includes the management server 60 as in the first and second embodiments, i.e., the management server 60 is not changed from that in the first and second embodiments. Thus, illustration and description of the management server 60 are omitted.

Each of the organization servers 200 is a server operated by an article delivery organization (companies, municipalities, media, or the like).

Each of the organization servers 200 delivers article information to the generative AI servers 210-1, 210-2, and 210-3 in response to crawling performed by the generative AI servers 210-1, 210-2, and 210-3. Each of the organization servers 200 permits or rejects the utilization of article information for generative AI in response to an application from a generative AI company. At this time, the organization servers 200 may determine whether to permit or reject the utilization of article information for the generative AI by use of a “determining unit” confirming or verifying the CP and PA issued to the generative AI company (previously issued by the management server 60).

For example, the “determining unit” may permit the utilization of article information for the generative AI when the CP and PA of the generative AI company are included in the application for the utilization of the article information for the generative AI received from the generative AI company (generative AI server). Conversely, the “determining unit” may reject the utilization of article information for the generative AI when the CP and PA of the generative AI company are not included in the application for the utilization of the article information for the generative AI received from the generative AI company (generative AI server).

Also, for example, the “determining unit” may permit the utilization of article information for the generative AI when succeeding in verification of the CP and PA of the generative AI company included in the application for the utilization of the article information for the generative AI received from the generative AI company (generative AI server). Conversely, the “determining unit” may reject the utilization of article information for the generative AI when failing in verification of the CP and PA of the generative AI company included in the application for the utilization of the article information for the generative AI received from the generative AI company (generative AI server).

The “determining unit” may determine whether to permit or reject the utilization of article information for the generative AI based on attribute information included in the CP and PA of the generative AI company.

For example, the “determining unit” may permit the utilization of article information for the generative AI when an evaluation score of the generative AI company indicated in the attribute information of the PA is equal to or greater than a predetermined score. Conversely, the “determining unit” may reject the utilization of article information for the generative AI when the evaluation score of the generative AI company indicated in the attribute information of the PA is less than the predetermined score.

As illustrated in (A1) of FIG. 8, each of the organization servers 200 allows a “license issuing unit” to issue a utilization license, which certifies the permission of the utilization of article information to the article information permitted for the utilization for the generative AI, and to transmit the utilization license to the generative AI company in which the utilization of the article information for the generative AI is permitted.

As illustrated in (A2) of FIG. 8, for each piece of article information, each of the organization servers 200 requests the CAL server 230 for registration of various types of information (e.g., application for utilization, permission for utilization, rejection of utilization, terms and conditions (fees, period, and the like)) concerning the utilization of the article information.

Also, for each piece of article information, each of the organization servers 200 issues an article CA, which is a certificate, issued using digital signature technology, that enables verification for the profile of the article information.

Also, for each piece of article information, each of the organization servers 200 generates an article CA (issued by the organization server 200), which is a certificate, issued using digital signature technology, that can verify that the article is not falsified, and CP and PA (issued by the management server 60) of an organization that delivers the article information.

Also, when delivering article information, each of the organization servers 200 includes, in the article information, article CA and CP, which are certificates, issued using digital signature technology, that can verify that the article is not falsified.

When processing is performed between the organization server 200 and the generative AI server 210, reliability may be bilaterally determined not only by the organization server 200 determining the reliability of the generative AI server 210 based on the SOP, but also by the generative AI server 210 determining the reliability of the organization server 200 based on the SOP.

The generative AI servers 210-1, 210-2, and 210-3 are servers operated by a generative AI company. The generative AI servers 210-1, 210-2, and 210-3 may be physically separate devices or may be physically the same device. The generative AI servers 210-1, 210-2, and 210-3 may be operated by the same generative AI company or may be operated by separate generative AI companies.

The generative AI servers 210-1, 210-2, and 210-3 perform crawling on the organization servers 200 existing in a communication network, such as the Internet or the like, thereby acquiring article information from each of the organization servers 200.

At this time, as illustrated in (B1) of FIG. 8, for each piece of article information, the generative AI servers 210-1, 210-2, and 210-3 file a utilization application of the article information for the generative AI with the organization server 200 of a source of delivery of the article information. Then, as illustrated in (B2) of FIG. 8, for each piece of article information, the generative AI servers 210-1, 210-2, and 210-3 receive a utilization license issued and transmitted by the organization servers 200 when the utilization of the article information is permitted by the organization server 200. However, there is no limitation on the method in which the generative AI servers 210-1, 210-2, and 210-3 receive the utilization license at the time of crawling. The generative AI servers 210-1, 210-2, and 210-3 may receive the utilization license by any other method (e.g., a method using an organization's application programming interface (API)).

Note that the generative AI server 210-1 performs pre-training in the generative AI. Specifically, as illustrated in (C1) of FIG. 8, the generative AI server 210-1 performs data processing (data replication or the like) on a plurality of pieces of article information (crawling data) collected from the organization servers 200, thereby generating a training dataset DS1. At this time, the generative AI server 210-1 attaches each piece of training data included in the training dataset DS1 with either or both of: the CP and PA of the generative AI company; and a certificate (CA), issued by the generative AI company using digital signature technology, that enables verification of the training data. Then, as illustrated in (C2) of FIG. 8, the generative AI server 210-1 generates a generative AI foundation model M1 from the training dataset DS1 in accordance with a pre-training model training program PG1.

Also, the generative AI server 210-2 performs additional training in the generative AI. Specifically, as illustrated in (D1) of FIG. 8, the generative AI server 210-2 generates an additional training dataset DS2 by performing data processing (data replication or the like) on a plurality of pieces of article information (crawling data) collected from the organization servers 200. At this time, the generative AI server 210-2 attaches each piece of training data included in the additional training dataset DS2 with either or both of: the CP and PA of the generative AI company; and a certificate (CA), issued by the generative AI company using digital signature technology, that enables verification of the training data. Then, as illustrated in (D2) of FIG. 8, the generative AI server 210-2 generates a generative AI trained model M2 from the generative AI foundation model M1 and the additional training dataset DS2 in accordance with a pre-training model additional training program PG2.

As illustrated in (E1) of FIG. 8, the generative AI server 210-3 generates an input dataset DS3 for retrieval augmented generation (RAG), which is a database for generative AI, by performing data processing (data replication or the like) on a plurality of pieces of article information (crawling data) collected from the organization servers 200. At this time, the generative AI server 210-3 attaches each piece of input data for RAG included in the input dataset DS3 for RAG with either or both of: the CP and PA of the generative AI company; and a certificate (CA), issued by the generative AI company using digital signature technology, that can verify that the input data for RAG is not falsified.

The terminal 220 is a device used by a viewer of answer information of generative AI. As illustrated in (F1) of FIG. 8, the terminal 220 inputs, to a search program PG3, question information of generative AI input from the viewer. As illustrated in (F2) of FIG. 8, the search program PG3 searches the input dataset DS3 for RAG using the input question information. As illustrated in (F3) of FIG. 8, the search program PG3 transmits, to a generative AI inference program PG4, the input question information and the search result for the input dataset DS3 for RAG.

At this time, the search program PG3 performs narrowed search on the input dataset DS3 for RAG based on information about the viewer (attributes, preferences, and the like) input from the terminal 220, and information described in the certificate (either or both of: CP and PA; and CA) attached to each piece of input data for RAG included in the input dataset DS3 for RAG, thereby acquiring more accurate search results in accordance with the information about the viewer.

Such narrowed search may be performed when the pre-training model training program PG1 generates the generative AI foundation model M1 and when the pre-training model additional training program PG2 generates the generative AI trained model M2.

Also, as illustrated in FIG. 8, the terminal 220 may perform transmission of the question information and reception of the answer information of the generative AI on the search program PG3 including the generative AI foundation model M1 or the search program PG3 including the generative AI trained model M2. In this case, the terminal 220 may transmit the OP user information described in the third embodiment along with the question information to the search program PG3 including the generative AI foundation model M1 or the search program PG3 including the generative AI trained model M2, and receive the answer information of the generative AI appropriate in accordance with the OP user information from the search program PG3 including the generative AI foundation model M1 or the search program PG3 including the generative AI trained model M2. Also, in this case, the terminal 220 may cause the consignment server 330 described in the third embodiment to transmit the OP user information to the search program PG3 including the generative AI foundation model M1 or the search program PG3 including the generative AI trained model M2.

Also, the search program PG3 includes the certificate (either or both of: CP and PA; and CA) in the search results input to the generative AI inference program PG4. Thus, the generative AI inference program PG4 can provide the terminal 220 with the generative AI answer information attached with the certificate (either or both of: CP and PA; and CA) (i.e., highly reliable generative AI answer information).

The generative AI inference program PG4 generates the generative AI answer information based on: the question information and the search results received from the search program PG3; and the generative AI trained model M2, and transmits the generative AI answer information to the terminal 220. As illustrated in (F4) of FIG. 8, the terminal 220 receives the generative AI answer information from the generative AI inference program PG4, and displays the generative AI answer information.

As illustrated in (G1) of FIG. 8, in response to a registration request from each of the organization servers 200, for each piece of article information, the CAL server 230 registers, in a database or the like, various types of information (e.g., application for utilization, permission for utilization, rejection of utilization, terms and conditions (fees, period, and the like)) concerning the utilization of the article information for the generative AI.

As described above, the generative AI system 4 according to the fourth embodiment causes the management server 60 to issue the CP and PA to: each organization that delivers article information; and each generative AI company that generates a generative AI model. Thus, it is possible to increase the reliability of each organization and each generative AI company. In addition, it is possible to increase the reliability of the article information delivered from each organization and the reliability of the data of the generative AI model generated by each generative AI company.

Also, according to the generative AI system 4 according to the fourth embodiment, each of the organization servers 200 includes the determining unit configured to determine whether or not to permit the generative AI company to utilize the article information for the generative AI based on the CP and PA of the generative AI company. Thus, for example, each of the organization servers 200 can permit only the generative AI company having high reliability to utilize the article information for the generative AI.

Also, according to the generative AI system 4 according to the fourth embodiment, the generative AI server 210-1 attaches each piece of training data included in the training dataset DS1 for pre-training with either or both of: the CP and PA of the generative AI company; and a certificate (CA), issued by the generative AI company using digital signature technology, that can verify that the training data is not falsified. Thus, it is possible to increase the reliability of each piece of training data included in the training dataset DS1 for pre-training and the reliability of each piece of data included in the generative AI model generated based on the training dataset DS1.

Also, according to the generative AI system 4 according to the fourth embodiment, the generative AI server 210-2 attaches each piece of training data included in the training dataset DS2 for additional training with either or both of: the CP and PA of the generative AI company; and a certificate (CA), issued by the generative AI company using digital signature technology, that can verify that the training data is not falsified. Thus, it is possible to increase the reliability of each piece of training data included in the training dataset DS2 for additional training and the reliability of each piece of data included in the generative AI model generated based on the training dataset DS2.

Also, according to the generative AI system 4 according to the fourth embodiment, the generative AI server 210-3 attaches each piece of input data for RAG included in the input dataset DS3 for RAG with either or both of: the CP and PA of the generative AI company; and a certificate (CA), issued by the generative AI company using digital signature technology, that can verify that the input data for RAG is not falsified. Thus, it is possible to increase the reliability of each piece of input data for RAG included in the input dataset DS3 for RAG.

In the generative AI system 4 according to the fourth embodiment, each of the organization servers 200 may attach article information with either or both of: the CP and PA of an organization; and the CA of the article information. In this case, it is possible to increase the reliability of the article information (i.e., article information used for training data) delivered from each of the organization servers 200. Also, in this case, for example, the generative AI servers 210-1, 210-2, and 210-3 can utilize only the highly reliable article information for the generative AI based on either or both of: the CP and PA of the organization; and the CA of the article information.

The datasets DS1, DS2, and DS3 may be attached with a certificate for each individual piece of data and a certificate for the entire dataset by the generative AI servers 210-1, 210-2, and 210-3, respectively.

In this case, the certificate for each individual piece of data may be a certificate generated (signed) by the generative AI server 210-1, 210-2, or 210-3, or may be the CA attached (signed) to the article information by an article information delivery source organization.

Also, in this case, the certificate for the entire dataset may be a certificate generated (signed) by the generative AI server 210-1, 210-2, or 210-3, or may be the utilization license or the like issued (signed) by an article information delivery source organization.

Also, each of the datasets DS1, DS2, and DS3 may be attached with respective certificates of a plurality of parties (an organization, a generative AI company, and the like) involved during a period up to generation of the dataset from article information. Thus, the datasets DS1, DS2, and DS3 may be such that the parties (an organization, a generative AI company, and the like) involved in the dataset can be confirmed retrospectively, i.e., the datasets DS1, DS2, and DS3 may be highly transparent.

Although the embodiments of the present disclosure have been described above in detail, the present disclosure is not limited to such specific embodiments. Various modifications and alterations are possible within the scope of the present disclosure of claims recited.

Functional units, i.e., the terminal 10, the content server 20, the ad server 30, the management server 60, the SSP 70, and the DSP 80 may be implemented, for example, through cloud computing provided by one or more computers. Also, a plurality of devices among the content server 20, the ad server 30, the advertiser server 40, the log server 50, the management server 60, the SSP 70, and the DSP 80 may be configured as an integrated device.

According to the delivery system according to one embodiment, it is possible to increase reliability of content (e.g., web content and articles) and information attached to the content (e.g., advertisements).

Note that each of the generative AI system, the generative AI generator, and the content providing system described above may have partially or substantially the same hardware configuration as those of the systems described above. For example, as illustrated in FIG. 2, the hardware configuration of each device included in the advertisement delivery system 1 may be at least partially employed in each of the article delivery system, the content providing system, the generative AI system, and the generative AI generator described above.

What is claimed is:

1. A delivery system, comprising:
a memory; and
a processor coupled to the memory, the processor being configured to:
attach a first certificate and a second certificate to an advertisement, upon web content attached with the advertisement being delivered to a terminal, in which the first certificate is a certificate of a profile of an advertiser of the advertisement, the first certificate is previously issued using digital signature technology through examination performed by a predetermined certification institution, the second certificate is a certificate of a profile of the advertisement, and the second certificate is previously issued by the advertiser using the digital signature technology and certifies that the advertisement is not falsified; and
determine reliability of the advertisement using the digital signature technology based on the first certificate and the second certificate that are attached to the advertisement.

2. The delivery system according to claim 1, wherein
the profile of the advertiser includes identification information of the advertiser, and the identification information is previously issued by the predetermined certification institution.

3. The delivery system according to claim 2, wherein
the processor is configured to:
attach a third certificate and a fourth certificate to the web content, wherein the third certificate is a certificate of a profile of an organization of a provider of the web content, the third certificate is previously issued through examination performed by the predetermined certification institution, the fourth certificate is a certificate of a profile of the web content, and the fourth certificate is previously issued by the organization of the provider of the web content and certifies that the web content is not falsified; and
determine reliability of the web content based on the third certificate and the fourth certificate that are attached to the web content.

4. The delivery system according to claim 3, wherein
the profile of the organization of the provider of the web content includes organization identification information of the organization of the provider of the web content, and the organization identification information is previously issued by the predetermined certification institution.

5. The delivery system according to claim 1, wherein
in a real-time bidding transaction between a first transaction server and a second transaction server, the first transaction server attaches a bid request with identification information of the first transaction server previously issued by the predetermined certification institution, and the second transaction server attaches a bid response with identification information of the second transaction server previously issued by the predetermined certification institution, and
the first transaction server confirms the identification information of the second transaction server, and the second transaction server confirms the identification information of the first transaction server.

6. The delivery system according to claim 1, wherein
the first certificate and the second certificate are both in compliance with a data model of an issuer holder verifier.

7. A delivery system, comprising:
a memory; and
a processor coupled to the memory, the processor being configured to:
attach a first certificate and a second certificate to an article, upon the article being delivered to a terminal, in which the first certificate is a certificate of a profile of an organization of a provider of the article, the first certificate is previously issued using digital signature technology through examination performed by a predetermined certification institution, the second certificate is a certificate of a profile of the article, and the second certificate is previously issued by the organization of the provider of the article using the digital signature technology and certifies that the article is not falsified; and
determine reliability of the article using the digital signature technology based on the first certificate and the second certificate that are attached to the article.

8. The delivery system according to claim 7, further comprising:
a redelivery platform configured to redeliver the article to the terminal, wherein
the redelivery platform determines the reliability of the article using the digital signature technology based on the first certificate and the second certificate that are attached to the article.

9. A delivery method, comprising:
attaching a first certificate and a second certificate to an advertisement, upon web content attached with the advertisement being delivered to a terminal, in which the first certificate is a certificate of a profile of an advertiser of the advertisement, the first certificate is previously issued using digital signature technology through examination performed by a predetermined certification institution, the second certificate is a certificate of a profile of the advertisement, and the second certificate is previously issued by the advertiser using the digital signature technology and certifies that the advertisement is not falsified; and
determining reliability of the advertisement using the digital signature technology based on the first certificate and the second certificate that are attached to the advertisement.

10. A delivery method, comprising:
attaching a first certificate and a second certificate to an article, upon the article being delivered to a terminal, in which the first certificate is a certificate of a profile of an organization of a provider of the article, the first certificate is previously issued using digital signature technology through examination performed by a predetermined certification institution, the second certificate is a certificate of a profile of the article, and the second certificate is previously issued by the organization of the provider of the article using the digital signature technology and certifies that the article is not falsified; and
determining reliability of the article using the digital signature technology based on the first certificate and the second certificate that are attached to the article.

11. A generative AI system including a generative AI generator configured to generate a generative AI model using training data that is article information collected from a communication network, the generative AI system comprising:
a memory; and
a processor coupled to the memory, wherein
the processor is configured to determine reliability of a generative AI company operating the generative AI generator using digital signature technology based on a certificate of a profile of the generative AI company, and
the certificate is previously issued using the digital signature technology through examination performed by a predetermined certification institution.

12. The generative AI system according to claim 11, wherein
the processor is configured, based on the certificate of the profile of the generative AI company issued using the digital signature technology, to determine whether or not to permit the generative AI company to utilize the article information for generative AI.

13. The generative AI system according to claim 12, wherein
the processor is configured to issue a utilization license to the generative AI company that is permitted to utilize the article information for the generative AI.

14. The generative AI system according to claim 11, wherein
the generative AI generator includes a memory and a processor coupled to the memory, the processor being configured to:
attach the training data with either or both of
a first certificate of a profile of the generative AI company issued using the digital signature technology, and
a second certificate of a profile of the training data that is issued by the generative AI company using the digital signature technology and certifies that the training data is not falsified; and
generate the generative AI model using the training data that is attached with either or both of the first certificate and the second certificate.

15. A generative AI method preformed by a generative AI system including a generative AI generator configured to generate a generative AI model using training data that is article information collected from a communication network, the generative AI method comprising:
determining reliability of a generative AI company operating the generative AI generator using digital signature technology based on a certificate of a profile of the generative AI company, wherein
the certificate is previously issued using the digital signature technology through examination performed by a predetermined certification institution.

16. A content providing system configured to provide a service from a service providing server to a terminal to which web content is delivered, the content providing system comprising:
a memory; and
a processor coupled to the memory, the processor being configured to:
record a first certificate and a second certificate as browsing log information, in which the first certificate is a certificate of a profile of an organization of a provider of the web content, the second certificate is a certificate of a profile of the web content that certifies that the web content is not falsified, and the first certificate and the second certificate are attached to the web content delivered to the terminal and are issued using digital signature technology; and
provide user information, acquired through an analysis process of the browsing log information, to the service providing server, thereby providing the terminal with the service in accordance with the user information.

17. A service providing method of providing a service from a service providing server to a terminal to which web content is delivered, the service providing method comprising:
recording a first certificate and a second certificate as browsing log information, in which the first certificate is a certificate of a profile of an organization of a provider of the web content, the second certificate is a certificate of a profile of the web content that certifies that the web content is not falsified, and the first certificate and the second certificate are attached to the web content delivered to the terminal and are issued using digital signature technology, and
providing user information, acquired through an analysis process of the browsing log information, to the service providing server, thereby providing the terminal with the service in accordance with the user information.
